(19) United States
(12) Patent Application Publication
(10) Pub. No.: US 2020/0382688 A1
(43) Pub. Date: Dec. 3, 2020

(54) DISPLAY METHOD, DISPLAY DEVICE, AND INFORMATION SYSTEM

(71) Applicant: SEIKO EPSON CORPORATION, Tokyo (JP)

(72) Inventors: Ryoki Watanabe, Matsumoto-shi (JP); Hikaru Kurasawa, Shiojiri-shi (JP); Teruyuki Nishimura, Matsumoto-shi (JP); Masashi Kanai, Azumino-shi (JP)

(73) Assignee: SEIKO EPSON CORPORATION, Tokyo (JP)

(21) Appl. No.: 16/886,900

(22) Filed: May 29, 2020

(30) Foreign Application Priority Data
May 30, 2019 (JP) 2019-101034

(51) Int. Cl. H04N 5/225; H04N 5/232; H04N 9/04; G06T 5/50

(52) U.S. Cl. CPC H04N 5/2258; H04N 5/232935; G06T 2207/20221; G06T 5/50; H04N 9/045

(57) ABSTRACT

A display method according to the present disclosure includes an imaging step of imaging inherent spectroscopic information provided to an object to be measured as a first image, and taking an image of the object different from the spectroscopic information as a second image, and a display step of inevitably displaying the second image and selectively displaying the first image out of the first image and the second image.

The present application is based on, and claims priority from JP Application Serial Number 2019-101034, filed May 30, 2019, the disclosure of which is hereby incorporated by reference herein in its entirety.

### BACKGROUND

### 1. Technical Field

The present disclosure relates to a display method, a display device, and an information system.

### 2. Related Art

In recent years, in an application or the like provided to an information terminal such as a smartphone, there has been known an electronic pictorial book of identifying the type of a measurement target such as a creature such as a fish, a shellfish, an insect, or a mammal, or plant such as a flower or a tree based on the image of the measurement target described above taken by a camera.

For example, JP-A-2008-152713 (Document 1) discloses an invention related an electronic pictorial book of identifying the type of a flower as the measurement target. In Document 1 described above, there is performed that “a color, the number, and shapes of petals, and the way of aggregation of the flower” as feature amounts of the flower, “shapes of leafs, shapes of edges of the leafs, and hairs or prickles of a stem” as feature amounts of the leafs, and so on are extracted from the image of the flower obtained, and then the type of the flower is identified based on these featured amounts, namely identification of the type of the flower based on the feature amounts such as the shape provided to the flower, and the size of the shape.

However, in such an electronic pictorial book, there is a problem that it becomes difficult to make recognition, and thus it is not achievable to identify the type of the measurement target when the measurement target in the taken image “is similar to a pattern in the background,” “faces to a different direction from a direction representing a shape for identifying the flower,” “runs off an imaged area,” and so on.

Such a problem is caused by the fact that the “shape” cannot be clipped when the feature amounts such as the shape of the measurement target and the size of the shape are used for identifying the type of the measurement target such as a flower as described above and the measurement target “is similar to a pattern in the background,” or caused by the fact that the measurement target is different from the “shape” stored in a database provided to the electronic pictorial book when the measurement target “faces to the front or the back,” and when the measurement target “runs off the imaged area.” In other words, such a problem is caused by the fact that it is difficult to extract the feature amounts based on the shape of the measurement target necessary for identifying the type of the measurement target.

Further, besides such an electronic pictorial book, there is proposed to perform the determination on whether or not the measurement target is a normal product based on spectroscopic information (spectral data) obtained by taking an image of the measurement target in a detection method (see, e.g., JP-A-2017-203658) for determining whether the measurement target as an inspection object is the normal product or an abnormal product.

Therefore, in the electronic pictorial book, it is conceivable that it is possible to identify the type of the measurement target by using the spectroscopic information obtained by imaging the measurement target as the information for extracting the feature amounts for identifying the type of the measurement target, namely using an inherent color tone provided to the measurement target even when it is difficult to extract the feature amounts based on the shape of the measurement target as described above.

Incidentally, when it is assumed that the electronic pictorial book is provided with a spectroscopic camera in order to obtain the spectroscopic information of the measurement target as described above, the pictures assuming the image to be taken are sequentially displayed in a display section provided to the spectroscopic camera in a standby state before taking the image with a view to making the measurement target fall within the image to be obtained by the spectroscopic camera (see, e.g., JP-A-2009-033222).

In this case, the spectroscopic camera converts the spectroscopic information into tristimulus values specified in International Commission on Illumination CIE, namely X, Y, and Z values, wherein the spectroscopic information is obtained by superimposing the spectral images obtained in the divisional regions obtained by dividing the wavelength region to be measured into a plurality of parts. Subsequently, by converting the X, Y, and Z values into R, G, and B values using a monitor profile and then supplying the result to the display section, the image of the measurement target is displayed on the display section. Then, by repeatedly performing the process of displaying the image, the pictures described above are displayed on the display section.

However, as described above, in the display method of forming an image to be displayed on the display section by obtaining the spectroscopic information by superimposing a plurality of spectral images on each other and then conversing into the X, Y, and Z values based on the spectroscopic information and then the R, G, and B values, since it takes time for the process of forming the image, it is conceivable that there arises the problem that dropping frames occurs in the picture to be displayed based on the images.

### SUMMARY

The present disclosure has an advantage of providing a solution to the problem described above, and can be implemented as the following application example.

A display method according to an application example of the present disclosure includes an imaging step of imaging inherent spectroscopic information provided to an object to be measured as a first image, and taking an image of the object different from the spectroscopic information as a second image, and a display step of inevitably displaying the second image and selectively displaying the first image out of the first image and the second image.

### BRIEF DESCRIPTION OF THE DRAWINGS

FIG. 1 is a plan view showing an obverse side of the whole image of a smartphone as an information terminal to which a first embodiment as an information system according to the present disclosure is applied.

FIG. 2 is a plan view showing a reverse side of the whole image of the smartphone as the information terminal to which the first embodiment as the information system according to the present disclosure is applied.

FIG. 3 is a cross-sectional view along the line A-A of the smartphone shown in FIG. 2.

FIG. 4 is a cross-sectional view along the line B-B of the smartphone shown in FIG. 2.

FIG. 5 is a block diagram showing a schematic configuration of the smartphone shown in FIG. 1 and FIG. 2.

FIG. 6 is a vertical cross-sectional view showing an example in which a variable wavelength interference filter provided to a spectroscopic section provided to a spectroscopic measurement section of the smartphone shown in FIG. 1 and FIG. 2 is applied to a Fabry-Perot etalon filter.

FIG. 7 is a flowchart showing an identification method of performing identification of the type of the measurement target with the smartphone shown in FIG. 1 and FIG. 2.

FIG. 8 is a schematic diagram for explaining inherent spectroscopic information provided to the measurement target obtained by imaging the measurement target with the smartphone shown in FIG. 1 and FIG. 2.

FIG. 9 is a flowchart showing a detection method of performing detection of the measurement target with the smartphone shown in FIG. 1 and FIG. 2.

FIG. 10 is a flowchart showing an appraisal method of performing appraisal of the measurement target with the smartphone shown in FIG. 1 and FIG. 2.

FIG. 11 is a flowchart showing a display method of displaying an image of the measurement target during a standby period of the smartphone shown in FIG. 1 and FIG. 2.

FIG. 12 is a block diagram showing a schematic configuration of a smartphone and a spectroscopic measurement section to which a second embodiment as the information system according to the present disclosure is applied.

FIG. 13 is a block diagram showing a schematic configuration of a smartphone and an external display section to which a third embodiment as the information system according to the present disclosure is applied.

FIG. 14 is a block diagram showing a schematic configuration of a smartphone, a spectroscopic measurement section, and an external display section to which a fourth embodiment as the information system according to the present disclosure is applied.

FIG. 15 is a block diagram showing a schematic configuration of a smartphone and a server to which a fifth embodiment as the information system according to the present disclosure is applied.

FIG. 16 is a block diagram showing a schematic configuration of a smartphone and a server to which a sixth embodiment as the information system according to the present disclosure is applied.

### DESCRIPTION OF EXEMPLARY EMBODIMENTS

Hereinafter, the display method, the display device, and the information system according to the present disclosure will be described in detail based on some preferred embodiments shown in the accompanying drawings.

It should be noted that the information system according to the present disclosure will hereinafter be described prior to describing the display method and the display device according to the present disclosure.

### Information System

### First Embodiment

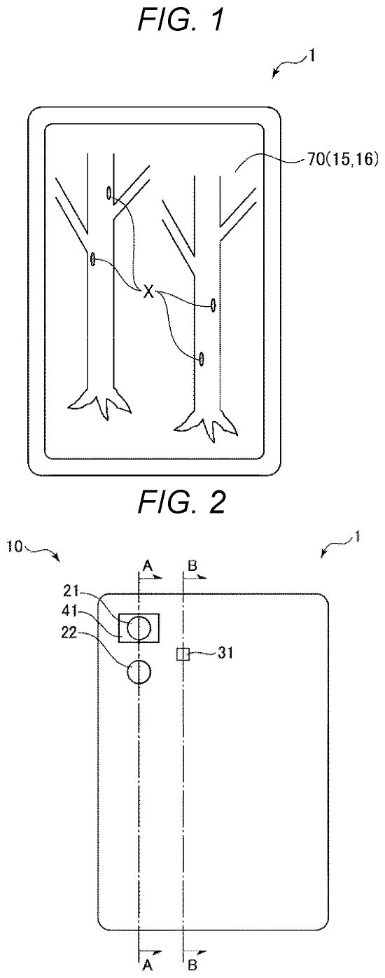

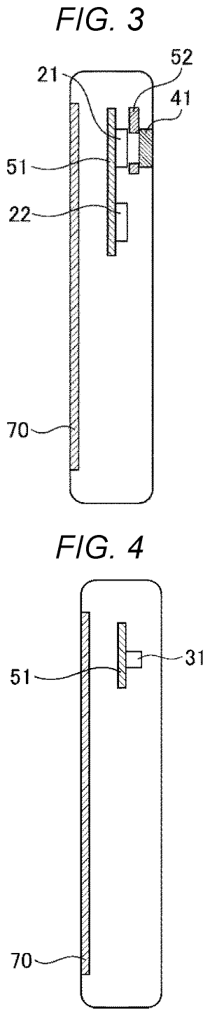

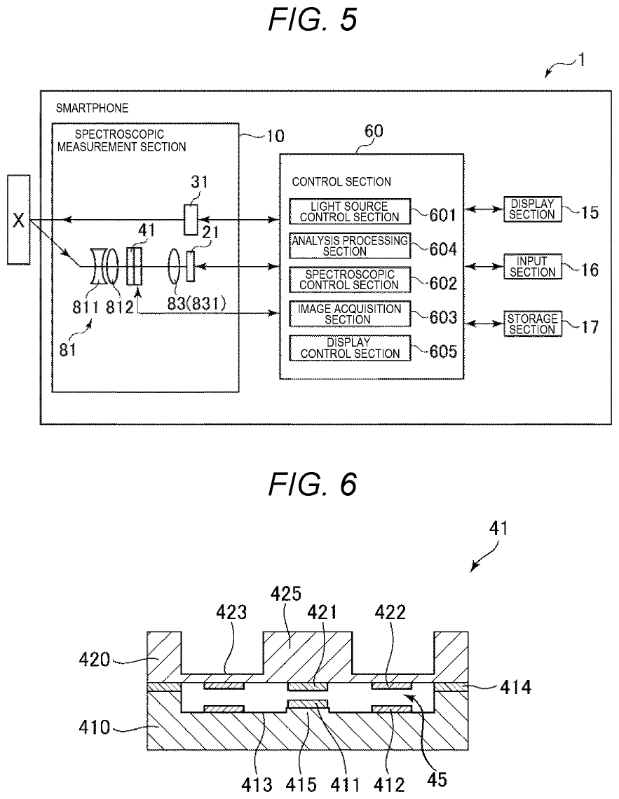

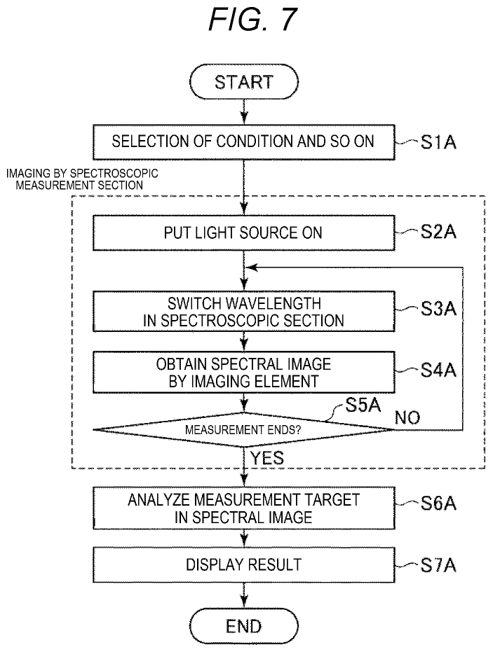

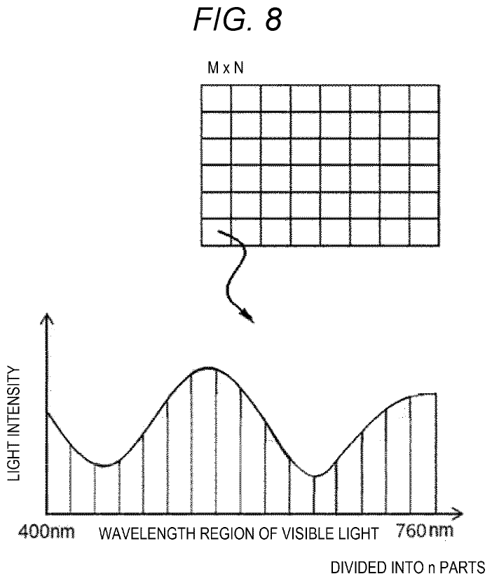

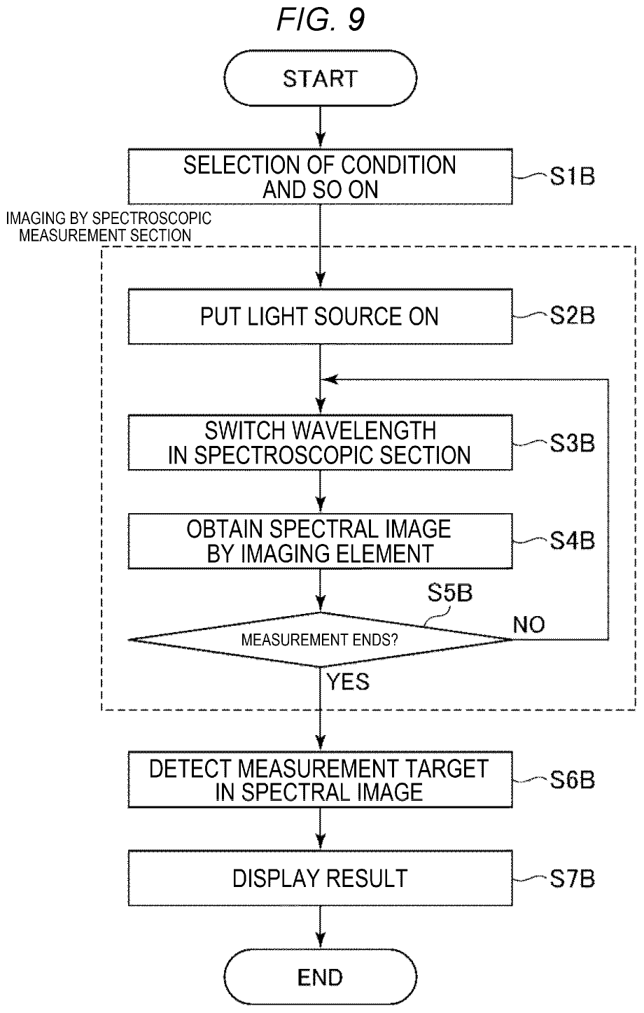

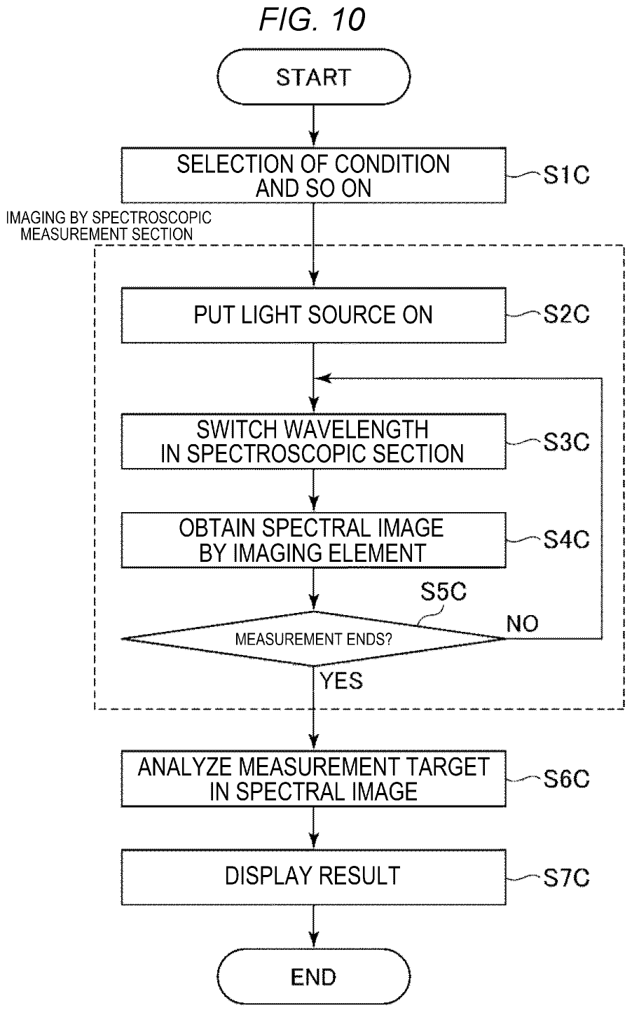

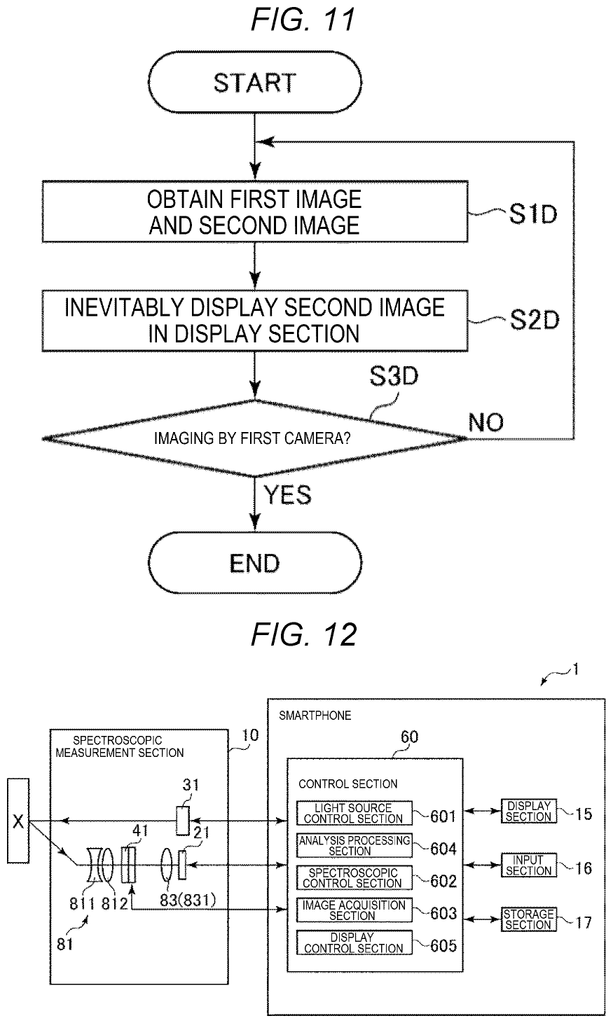

FIG. 1 is a plan view showing an obverse side of the whole image of a smartphone as an information terminal to which a first embodiment as an information system according to the present disclosure is applied, FIG. 2 is a plan view showing a reverse side of the whole image of the smartphone as the information terminal to which the first embodiment as the information system according to the present disclosure is applied, FIG. 3 is a cross-sectional view along the line A-A of the smartphone shown in FIG. 2, FIG. 4 is a cross-sectional view along the line B-B of the smartphone shown in FIG. 2, FIG. 5 is a block diagram showing a schematic configuration of the smartphone shown in FIG. 1 and FIG. 2, FIG. 6 is a vertical cross-sectional view showing an example in which a variable wavelength interference filter provided to a spectroscopic section provided to a spectroscopic measurement section of the smartphone shown in FIG. 1 and FIG. 2 is applied to a Fabry-Perot etalon filter, FIG. 7 is a flowchart showing an identification method of performing identification of the type of a measurement target with the smartphone shown in FIG. 1 and FIG. 2, FIG. 8 is a schematic diagram for explaining inherent spectroscopic information provided to the measurement target obtained by imaging the measurement target with the smartphone shown in FIG. 1 and FIG. 2, FIG. 9 is a flowchart showing a detection method of performing detection of the measurement target with the smartphone shown in FIG. 1 and FIG. 2, FIG. 10 is a flowchart showing an appraisal method of performing appraisal of the measurement target with the smartphone shown in FIG. 1 and FIG. 2, and FIG. 11 is a flowchart showing a display method of displaying an image of the measurement target during a standby period of the smartphone shown in FIG. 1 and FIG. 2.

Hereinafter, in the present embodiment, there is described when applying the information system according to the present disclosure to a smartphone 1 (SP) as a kind of information terminal, namely when an information system according to the present disclosure is completed with the smartphone 1 alone as the information terminal.

The smartphone 1 is a kind of a portable information terminal provided with an imaging function, and has a first camera for imaging inherent spectroscopic information provided to a measurement target X to be measured, namely an object, as a first image, a second camera for taking an image of an object different from the spectroscopic information as a second image, and a display section 15 capable of displaying the first image and the second image, and the display section 15 is configured so as to be able to inevitably display the second image, and selectively display the first image.

In such a smartphone 1, the first camera has a spectroscopic measurement section 10 formed of a spectroscopic camera for obtaining the inherent spectroscopic information provided to the measurement target X as the first image, namely the spectral image, and the second camera is formed of an RGB camera for obtaining the second image of the measurement target X different from the spectroscopic information as an RGB image in the present embodiment.

In this smartphone 1, an electronic pictorial book, a detection device, and an appraisal device using the smartphone 1 described later are executed using the spectroscopic camera out of the first camera and the second camera, namely the spectroscopic camera and the RGB camera. Therefore, hereinafter, there is mainly described a configuration of each section including the spectroscopic camera, namely the spectroscopic measurement section 10 to be driven by the smartphone 1 when using the smartphone 1 as the electronic pictorial book, the detection device, and the appraisal device.

It should be noted that when the electronic pictorial book for identifying the type of a creature, a plant, or the like as the measurement target X is started up as an application provided to the smartphone 1, the type of the creature, the plant, or the like thus identified, and in addition, detailed information thereof and so on are displayed on the display section 15.

Further, when the detection method of detecting presence or absence of a creature, a plant, or the like as the measurement target X in the image thus taken, namely the imaged area, and the position where the creature, the plant, or the like is located is started up as the application described above, the type of the creature, the plant, or the like thus detected, the position where the creature, the plant, or the like exists, and in addition, the probability that the creature, the plant, or the like exists, and so on are displayed on the display section 15. It should be noted that in FIG. 1, the position where an insect such as a beetle or a stag beetle as the measurement target X sits on a tree is identified and is displayed on the display section 15.

Further, when an appraisal method of appraising authenticity of an article such as a bag, a wallet, a watch, or a jewel as the measurement target X in the image thus taken or a degree of aged deterioration thereof is started up as the application described above, the authenticity and the degree of aged deterioration of the article thus identified, namely appraised, an authenticity rate and a position where the aged deterioration occurs, and so on are displayed on the display section 15.

Further, in order to identify the measurement target X using the smartphone 1, the wavelength region to be obtained is not limited to the region selected from the visible light region, but can also be a region selected from an infrared light region, an ultraviolet light region, or the like.

### Display Section 15, Input Section 16

In the smartphone 1, a display 70 is provided with functions of both of the display section 15 and an input section 16, and the display section 15 is formed of a variety of types of display device such as a liquid crystal display or an organic EL display. As shown in FIG. 1, the display section 15 is disposed on the obverse side of the smartphone 1, and displays a variety of types of visualized image including the information of the measurement target X thus identified. It should be noted that in the present disclosure, the display section 15 and the input section 16 can also be disposed separately from each other.

As the visualized image to be displayed on the display section 15, namely the information of the measurement target X thus identified, there can be cited, for example, information such as features, classification, components, characteristics of the measurement target X, and further, presence or absence and the position of the measurement target X in the imaged area, recognition accuracy (%) and an existence probability (%) of the measurement target X, and the probability (%) of the authenticity and the degree (%) of deterioration of the measurement target X in addition to the image of the measurement target X thus identified.

Further, the input section 16 is formed of, for example, a touch panel which is disposed on the surface of the display section 15, and is provided with a touch sensing surface and a sensor for detecting the strength of the contact with the touch sensing surface, and receives an operation instruction by a user (an operator), namely a condition or the like for obtaining the inherent spectroscopic information provided to the measurement target X, input thereto.

It should be noted that when setting the smartphone 1 to the standby state before obtaining the spectral image using the spectroscopic camera when using the smartphone 1 in the electronic pictorial book, the detection device, or the appraisal device, the second image obtained by the RGB camera is inevitably displayed, and the first image obtained by the spectroscopic camera, namely the spectroscopic measurement section 10 is selectively displayed on the display section 15 in the present disclosure, and the details thereof will be described later.

### Storage Section 17

A storage section 17 is constituted by a variety of types of storage devices (memory devices) such as a ROM and a RAM, and stores a variety of types of data, programs, and so on necessary for the control of the smartphone 1, in particular for the control of the spectroscopic measurement section 10.

As the data described above, there can be cited, for example, V-λ data as correlation data representing the wavelength of the transmitted light to the drive voltage to be applied to an electrostatic actuator 45 provided to a Fabry-Perot etalon filter of a spectroscopic section 41, and a database for identifying the type of the measurement target X based on the inherent spectroscopic information provided to the measurement target X in addition to application programs for realizing the functions of a control section 60, and so on. It should be noted that the database mentioned here represents the spectroscopic information with respect to each of creatures such as a fish, a shellfish, an insect, and a mammal, plants such as a flower and a tree, an article such as a bag, a wallet, a watch, and a jewel, and so on including the measurement target X to be identified.

### Spectroscopic Measurement Section 10

The spectroscopic measurement section 10 is a so-called a spectroscopic camera which receives the reflected light reflected by the measurement target X and then disperses the light to thereby obtain light with a specific wavelength or in a specific wavelength region (hereinafter, representatively described in “Specific Wavelength”) thus selected, and then images the light having the specific wavelength to thereby obtain the spectroscopic information as the first image, and in the present embodiment, the spectroscopic camera functions as the first camera.

In the present embodiment, the spectroscopic measurement section 10 is provided with a light source 31 for irradiating the measurement target X, namely the imaging target, with the light, an imaging element 21 for taking the image based on the reflected light reflected by the measurement target X, and the spectroscopic section 41 which selectively emits the light with a predetermined wavelength out of the incident light, and is capable of changing the wavelength or the wavelength region of the outgoing light to be emitted.

In such a spectroscopic measurement section 10, the spectroscopic section 41 is disposed between the imaging element 21 and the measurement target X in the state in which the light source 31 and the imaging element 21 are arranged so as to face to the same direction on the reverse surface side of the smartphone 1 as shown in FIG. 2. By arranging the light source 31, the spectroscopic section 41, and the imaging element 21 in such a positional relationship, it is possible to constitute the spectroscopic measurement section 10 by a post-dispersive type spectroscopic camera using these constituents. In such a post-dispersive type spectroscopic camera, by scanning the wavelength in a certain measurement range (a predetermined region), it is possible to obtain the specific wavelength and the spectrum shape to figure out the characteristics of the measurement target X. Therefore, it is an effective method when measuring, namely imaging, the measurement target X the specific wavelength of which is unknown.

It should be noted that the spectroscopic measurement section 10 can also constitute a pre-dispersive type spectroscopic camera in which the spectroscopic section 41 is disposed between the light source 31 and the measurement target X. In the pre-dispersive type spectroscopic camera having such a configuration, there is adopted a system capable of figuring out the characteristics of the measurement target X by performing the irradiation with the light having the specific wavelength. Therefore, the system is effective when measuring the measurement target X the specific wavelength of which has been known, and is a system having an advantage that the reduction in measurement time is achieved since an amount of the information can be made smaller than in the post-dispersive type.

The configuration of each of the sections provided to the spectroscopic measurement section 10 will hereinafter be described.

### Light Source 31

The light source 31 is an optical element for irradiating the measurement target X with illumination light.

As shown in FIG. 2 and FIG. 4, the light source 31 is disposed on a circuit board 51 disposed inside a housing of the smartphone 1 on the reverse surface side of the smartphone 1 so as to be able to irradiate the measurement target X with the illumination light.

The spectroscopic section is not disposed between the light source 31 and the measurement target X, and thus, the measurement target X is directly irradiated with the light emitted from the light source 31.

As such a light source 31, there can be cited, for example, an LED light source, an OLED light source, a xenon lamp, or a halogen lamp, and there is preferably used the light source having light intensity in the entire wavelength region in which the spectroscopic measurement is performed by the spectroscopic section 41 constituted by a variable wavelength interference filter, namely a light source capable of performing the irradiation with white light having the light intensity throughout the entire visible range. Further, the light source 31 can also be provided with a light source capable of performing the irradiation with the light having a predetermined wavelength such as infrared light besides a white light source.

### Imaging Element 21

The imaging element 21 takes the image based on the reflected light reflected by the measurement target X to thereby function as a detection section for detecting the reflected light reflected by the measurement target X.

As shown in FIG. 2 and FIG. 3, the imaging element 21 is disposed on the circuit board 51 disposed inside the housing of the smartphone 1 on the reverse surface side of the smartphone 1 so as to be able to receive the reflected light reflected by the measurement target X.

Further, the spectroscopic section 41 is disposed between the imaging element 21 and the measurement target X. Thus, the outgoing light having the predetermined wavelength is selectively emitted out of the incident light having entered the spectroscopic section 41 from the measurement target X, and the outgoing light is imaged by the imaging element 21 as the spectral image, namely the spectroscopic information.

Such an imaging element 21 is formed of, for example, a CCD or a CMOS.

### Spectroscopic Section 41

The spectroscopic section 41 is a device which selectively emits the light with the spectral wavelength as the specific wavelength out of the incident light, and is capable of changing the wavelength region of the outgoing light to be emitted. In other words, the spectroscopic section 41 is a device for emitting the light with the specific wavelength as the outgoing light toward the imaging element 21 out of the incident light.

As shown in FIG. 3, the spectroscopic section 41 is disposed on a circuit board 52 disposed inside the housing of the smartphone 1.

The spectroscopic section 41 is disposed between the imaging element 21 and the measurement target X, namely on the optical axis between these constituents. Thus, the outgoing light having the specific wavelength is selectively emitted toward the imaging element 21 out of the incident light having entered the spectroscopic section 41 from the measurement target X.

Such a spectroscopic section 41 is formed of a variable wavelength interference filter so as to be able to change the wavelength region of the outgoing light to be emitted. Although not particularly limited, as the variable wavelength interference filter, there can be cited, for example, a variable wavelength Fabry-Perot etalon filter which controls the size of a gap between two filters (mirrors) with an electrostatic actuator to thereby control the wavelength of the reflected light to be transmitted, an acousto-optic tunable filter (AOTF), a linear variable filter (LVF), and a liquid crystal tunable filter (LCTF), and among these filters, it is preferable to use the Fabry-Perot etalon filter.

The Fabry-Perot etalon filter is a device for extracting the reflected light with the desired wavelength using multiple interference due to the two filters. Therefore, it is possible to make the thickness dimension extremely small, and specifically, it becomes possible to set the thickness dimension no larger than 2.0 mm. Therefore, the smartphone 1 provided with the spectroscopic section 41, by extension, the spectroscopic measurement section 10 can be made smaller in size. Therefore, by using the Fabry-Perot etalon filter as the variable wavelength filter, it is possible to achieve further reduction in size of the spectroscopic measurement section 10.

The spectroscopic section 41 in which the variable wavelength type Fabry-Perot etalon filter is applied as the variable wavelength interference filter will hereinafter be described with reference to FIG. 6.

The Fabry-Perot etalon filter is an optical member shaped like a rectangular plate in a plan view, and is provided with a stationary substrate 410, a movable substrate 420, a stationary reflecting film 411, a movable reflecting film 421, a stationary electrode 412, a movable electrode 422, and a bonding film 414. Further, the stationary substrate 410 and the movable substrate 420 are integrally bonded to each other via the bonding film 414 in a stacked state.

The stationary substrate 410 is provided with a groove 413 formed by etching with respect to the thickness direction surrounding a central part so as to forma reflecting film installation part 415 in the central part. In the stationary substrate 410 having such a configuration, a stationary optical mirror formed of the stationary reflecting film 411 is disposed on the movable substrate 420 side of the reflecting film installation part 415, and the stationary electrode 412 is disposed on the movable substrate 420 side of the groove 413.

Further, the movable substrate 420 is provided with a holding section as a groove 423 formed by etching with respect to the thickness direction surrounding a central part so as to form a movable part as a reflecting film installation part 425 in the central part. In the movable substrate 420 having such a configuration, a movable optical mirror formed of the movable reflecting film 421 is disposed on the stationary substrate 410 side, namely the lower surface side, of the reflecting film installation part 425, and the movable electrode 422 is disposed on the stationary substrate 410 side.

The movable substrate 420 is formed so that the thickness dimension of the groove 423 is smaller compared to the reflecting film installation part 425, and thus, the groove 423 functions as a diaphragm deformed by an electrostatic attractive force applied when applying a voltage between the stationary electrode 412 and the movable electrode 422.

The stationary substrate 410 and the movable substrate 420 can be manufactured as long as the thickness thereof is in a range of no smaller than about 0.1 mm and no larger than about 1.0 mm. Therefore, since the total thickness of the Fabry-Perot etalon filter as a whole can be set no larger than 2.0 mm, it is possible to realize reduction in size of the spectroscopic measurement section 10.

Between such a stationary substrate 410 and such a movable substrate 420, the stationary reflecting film 411 and the movable reflecting film 421 are disposed so as to be opposed to each other via a gap in a substantially central part of the stationary substrate 410 and the movable substrate 420. Further, the stationary electrode 412 and the movable electrode 422 are disposed so as to be opposed to each other via a gap in the groove part surrounding the central part. Among these constituents, the stationary electrode 412 and the movable electrode 422 constitute the electrostatic actuator 45 for controlling the size of the gap between the stationary reflecting film 411 and the movable reflecting film 421.

Due to an electrostatic attraction force generated by applying a voltage between the stationary electrode 412 and the movable electrode 422 constituting the electrostatic actuator 45, the deformation occurs in a holding part as the groove 423. As a result, it is possible to change the size of the gap, namely the distance, between the stationary reflecting film 411 and the movable reflecting film 421. Further, by appropriately setting the size of the gap, it is possible to select the wavelength of the light to be transmitted, namely to selectively emit the light with the desired wavelength (wavelength region) out of the incident light. Further, by changing the configuration of the stationary reflecting film 411 and the movable reflecting film 421, it is possible to control the half bandwidth of the light to be transmitted, namely the resolution of the Fabry-Perot etalon filter.

It should be noted that the stationary substrate 410 and the movable substrate 420 are each formed of, for example, a variety of types of glass such as soda glass, crystalline glass, quartz glass, lead glass, potassium glass, borosilicate glass, or alkali-free glass or quartz crystal, the bonding film 414 is formed of, for example, a plasma-polymerized film having siloxane as a chief material, the stationary reflecting film 411 and the movable reflecting film 421 are each formed of, for example, a metal film made of Ag or the like or an alloy film made of an Ag alloy or the like, and in addition, formed of a dielectric multilayer film provided with TiO₂ as a high-refractive-index layer and SiO₂ as a low-refractive-index layer, and further, the stationary electrode 412 and the movable electrode 422 are each formed of a variety of types of electrically-conductive material.

### Optical Systems 81, 83

Further, in the present embodiment, the spectroscopic measurement section 10 is a device having a configuration including optical systems 81, 83 constituted by a variety of optical components as shown in FIG. 5.

The first spectroscopic section side optical system is disposed between the measurement target X and the spectroscopic section 41, and is provided with an incident lens 811 as an incident optical system and a projection lens 812 to guide the reflected light reflected by the measurement target X to the spectroscopic section 41.

Further, the first imaging element side optical system 83 is disposed between the spectroscopic section 41 and the imaging element 21, and is provided with an incident/exit lens 831 to guide the outgoing light emitted by the spectroscopic section 41 to the imaging element 21.

By providing the spectroscopic measurement section 10 with at least one of such optical systems 81, 83, it is possible to achieve an improvement in light-gathering rate by the imaging element 21 of the reflected light reflected by the measurement target X.

It should be noted that at least one of the optical systems 81, 83 can be eliminated taking the light-gathering rate by the imaging element 21 into consideration.

Further, the first spectroscopic section side optical system 81 can also form a configuration of being disposed between the spectroscopic section 41 and the first imaging element side optical system 83 besides when forming such an arrangement as described above.

### Control Section 60

The control section 60 is disposed inside the housing provided to the smartphone 1, and is formed of a processor having, for example, a CPU and a memory combined with each other, and controls operations of the constituents such as the light source 31, the imaging element 21, and the spectroscopic section 41, namely the overall operation or the operations of the constituents of the spectroscopic measurement section 10, and at the same time, controls an operation of the display section 15 and input/output of the data to/from the storage section 17. With regard to controlling the operation of the spectroscopic measurement section 10, the control section 60 can be said to correspond to, or include a “spectroscopic measurement section control section,” and controls an operation of the spectroscopic measurement section 10, namely the spectroscopic camera as the first camera, and further controls an operation of the RGB camera as the second camera described later.

More specifically, the control section 60 reads software such as a program stored in the storage section 17 based on an operation instruction by the user input to the input section 16, namely the condition for obtaining the inherent spectroscopic information provided to the measurement target X to thereby control the operations of the light source 31, the spectroscopic section 41, and the imaging element 21. Further, the control section 60 performs, for example, identification of the measurement target X based on the spectral image, namely the spectroscopic information, thus obtained, and then displays, in the display section 15, the information such as the type and the features of the measurement target X, and presence or absence of the existence in the imaged area.

In the present embodiment, the control section 60 is provided with a light source control section 601, a spectroscopic control section 602, and image acquisition section 603, an analysis processing section 604, and a display control section 605 as shown in FIG. 5.

The light source control section 601 is for controlling lighting and extinction of the light source 31 based on the operation instruction by the user input to the input section 16, specifically the condition for obtaining the inherent spectroscopic information provided to the measurement target X.

The spectroscopic control section 602 obtains the voltage value (an input value) of a drive voltage corresponding to the spectral wavelength, namely the specific wavelength, to be emitted based on the V-λ data stored in the storage section 17. Further, the spectroscopic control section 602 outputs a command signal for applying the voltage value thus obtained to the electrostatic actuator 45 of the Fabry-Perot etalon filter as the spectroscopic section 41. In other words, the spectroscopic control section 602 controls the operation of the spectroscopic section 41 to identify the magnitude of the specific wavelength of the light to be emitted from the spectroscopic section 41. Further, the spectroscopic control section 602 performs detection of a change timing of the measurement wavelength, a change of the measurement wavelength, a change of the drive voltage corresponding to the change in the measurement wavelength, a determination of the end of the measurement, and so on based on a variety of types of data stored in the storage section 17, and then outputs a command signal based on the determination.

The image acquisition section 603 obtains (images) light intensity measurement data (intensity of the light received) based on the reflected light reflected by the measurement target X as the spectral image, namely the spectroscopic information, in the imaging element 21, and then stores the spectral image thus obtained in the storage section 17. It should be noted that the image acquisition section 603 also stores the measurement wavelength at which the spectral image is obtained together with the spectral image in the storage section 17 when storing the spectral image in the storage section 17.

The analysis processing section 604 obtains the spectral image and the measurement wavelength, namely the dispersion spectrum, of the measurement target X stored in the storage section 17 as the spectroscopic information, and then performs an analytical process thereof. Specifically, by performing a spectroscopic process of comparing the dispersion spectrum as the spectroscopic information and the database stored in the storage section 17 with each other, the identification of the measurement target X thus imaged is performed.

It should be noted that the acquisition of the spectral image and the measurement wavelength by the analysis processing section 604 can also be performed directly from the image acquisition section 603 without the intervention of the storage section 17.

The display control section 605 displays the information of the measurement target X identified by the analysis processing section 604 on the display section 15 as a visualized image.

It should be noted that in the control section 60 having such a configuration, the light source control section 601, the spectroscopic control section 602, and the image acquisition section 603 constitute a spectroscopic measurement section control section for controlling the operations of the light source 31, the spectroscopic section 41, and the imaging element 21, namely the operation of the spectroscopic measurement section 10.

In the smartphone 1 described hereinabove, namely the smartphone 1 provided with the spectroscopic camera as the first camera, by selecting the type of the application to be started up, namely by selecting the usage of the smartphone 1, it is possible to use the smartphone 1 as (1) an electronic pictorial book for identifying the type of a creature, a plant, or the like as the measurement target X, (2) a detection device for detecting presence or absence of the creature, the plant, or the like as the measurement target X in the image thus taken, and the position of the existence, or (3) an appraisal device for appraising the authenticity and the degree of aged deterioration of an article as the measurement target X in the image thus taken. The usage of the smartphone 1 when used as the device for realizing the items (1) through (3) will hereinafter be described.

### (1) Usage as Electronic Pictorial Book

An identification method of identifying the type of a creature, a plant, or the like as the measurement target X using the smartphone 1 described above as the electronic pictorial book will hereinafter be described in detail using FIG. 7 and so on.

In the identification method using the smartphone 1 as the electronic pictorial book, the measurement target X is imaged using the spectroscopic measurement section 10, and the identification of the measurement target X is performed based on the spectral image thus taken. Subsequently, the image, the type, the detailed description, and so on of the measurement target X thus identified are displayed on the display 70.

### 1A

Firstly, the user operates the input section 16 to start up the application for using the smartphone 1 as the electronic pictorial book, and then performs (S1A) selection of the condition and so on as needed in accordance with the instruction by the application.

It should be noted that as the condition to be input in accordance with the instruction by the application, there can be cited, for example, the classification such as a flower, a fish, or a mammal, namely the group, of the measurement target X. The detection of the measurement target X with the smartphone 1 can promptly be performed by inputting the classification of the measurement target X in advance as described above, the details of which will be described later.

### 2A

Subsequently, the user operates the input section 16 to make an input instruction of imaging the measurement target X with the smartphone 1, namely the spectroscopic measurement section 10, and then, the control section 60 controls the operation of the spectroscopic measurement section 10 to perform imaging of the measurement target X in the specific wavelength based on the input instruction.

### 2A-1

Firstly, the light source control section 601 lights (S2A) the light source 31 in accordance with the input instruction of imaging the measurement target X by the user in the input section 16.

By lighting the light source 31, the measurement target X is irradiated with the illumination light emitted from the light source 31. Then, the light with which the measurement target X is irradiated is reflected by the measurement target X, and the light thus reflected enters the spectroscopic section 41 as the incident light.

### 2A-2

Subsequently, the spectroscopic control section 602 obtains the voltage value (the input value) of the drive voltage corresponding to the spectral wavelength, namely the specific wavelength, to be emitted based on the V-λ data stored in the storage section 17. Further, the spectroscopic control section 602 outputs (S3A) the command signal for applying the voltage value thus obtained to the electrostatic actuator 45 of the Fabry-Perot etalon filter as the spectroscopic section 41.

Thus, the light having the specific wavelength is selectively emitted as the outgoing light toward the imaging element 21 out of the light having entered the spectroscopic section 41 as the incident light from the measurement target X.

It should be noted that it is preferable for the spectroscopic control section 602 to perform an adjustment process of performing a calibration of the spectroscopic section 41 before making the spectroscopic section 41 emit the light having the specific wavelength. Thus, the dispersion spectrum s_{ref} of the light source 31 is obtained.

### 2A-3

Subsequently, the image acquisition section 603 controls the operation of the imaging element 21 to thereby obtain the light having the specific wavelength emitted as the outgoing light from the spectroscopic section 41 as the spectral image using the imaging element 21. In other words, the image acquisition section 603 obtains the light intensity measurement data (the intensity of the light received) in the light having the specific wavelength as the spectral image out of the reflected light reflected by the measurement target X using the imaging element 21. Then, the image acquisition section 603 stores (S4A) the spectral image thus obtained in the storage section 17 together with the measurement wavelength corresponding to the spectral image, namely the specific wavelength.

In such an acquisition method of the spectral image, the spectroscopic section 41 is disposed on the optical axis of the received light by the imaging element 21 between the measurement target X and the imaging element 21. Thus, only the light having the specific wavelength provided to the light reflected by the measurement target X is transmitted through the spectroscopic section 41, and the intensity of the light in the specific wavelength is spectroscopically measured by the imaging element 21 as the spectral image.

### 2A-4

Subsequently, after obtaining the spectral image in the light having the first specific wavelength, whether or not the acquisition of the spectral image in the light having the second specific wavelength different from the first specific wavelength is necessary is determined based on the condition selected by the user and so on in the process “1A” described above. In other words, whether or not it is necessary to subsequently obtain the spectral image in the light having the second specific wavelength different from the first specific wavelength is determined (S5A).

In this determination (S5A), when it is necessary to obtain the spectral image in the light having the second specific wavelength, the process “2A-2” described above through the present process “2A-4” are repeatedly performed with respect to the light having the second specific wavelength instead of the light having the first specific wavelength. In other words, the voltage value to be applied between the stationary electrode 412 and the movable electrode 422 of the electrostatic actuator 45 is changed to a value corresponding to the second specific wavelength, and then the process “2A-2” described above through the present process “2A-4” are repeatedly performed. Thus, the spectral image in the light having the second specific wavelength is obtained. The acquisition of the spectral image in the light having such a second specific wavelength, namely the different specific wavelength, is repeatedly performed at the first time, the second time through the n-th time. As described above, by repeatedly perform the process “2A-2” described above through the present process “2A-4,” it is possible to obtain the spectroscopic information as the spectral information Sₛₐₘ representing the relationship between each of the specific wavelengths and the light intensity corresponding to each of the pixels included in the spectral image.

In other words, in FIG. 8, the spectral information Sₛₐₘ is represented as a graph showing a relationship between each of the specific wavelengths obtained by dividing the wavelength region no less than 400 nm and no more than 760 nm as the wavelength region of the visible light into n parts and the light intensity, and the graph, namely the spectral information, is obtained as the total spectroscopic information provided to each of the M×N pixels as a result.

In contrast, when it is not necessary to obtain the spectral image in the light having the next wavelength, the acquisition of the spectral image by the spectroscopic measurement section 10 is terminated, and the transition to the next process “3A” is made.

### 3A

Subsequently, the analysis processing section 604 performs (S6A) the analysis of the spectral image based on the spectral images and the specific wavelengths of the measurement target X, namely based on the spectral information sₛₐₘ, stored in the storage section 17.

In other words, the analysis processing section 604 obtains the spectral information sₛₐₘ stored in the storage section 17 in the process “2A” described above. Subsequently, by performing the analytical process of comparing with the database using the spectral information sₛₐₘ, which is the spectroscopic information, as a feature amount, the identification of the measurement target X thus imaged is performed.

Specifically, the reflectance r=sₛₐₘ/s_{ref} of the measurement target X is calculated from the spectral information sₛₐₘ and the dispersion spectrum s_{ref} of the light source 31.

Then, by obtaining data rⁱ included in what corresponds to a group i=1, M stored in advance in the storage section 17, and then determining which one of the items included in the group i the reflectance r of the measurement target X belongs to using the data rⁱ, the analysis processing section 604 identifies the measurement target X. It should be noted here that the “group” means a classification or a small classification such as the flower, the fish, or the mammal which the measurement target X belongs to, and the data of the group corresponding to the classification of the measurement target X input in advance is obtained in the process “1A” described above.

More specifically, firstly, a function for projecting the spectral information sₛₐₘ as the feature amount on a discriminant space suitable to determine what group the spectral information sₛₐₘ belongs to, namely a projection function f(⋅), is made based on a specific discriminant criterion. It should be noted that as the discriminant criterion, there can be cited, for example, a Fisher discriminant criterion and a least square criterion. Further, the reflectance r of the measurement target X is projected on the discriminant space to be defined as y.

y=f(r)

Similarly, the data r′ of the group i=1, . . . , M are also projected on the discriminant space to be defined as y(rⁱ). Then, distances mⁱ (i=1, . . . , M) in the discriminant space between a position y on the discriminant space of the measurement target X and the group i=1, . . . , M are calculated.

mⁱ (i=1, . . . ,M)=g(y,y(rⁱ))

Here, y(rⁱ) represents an aggregate of the positions on the discriminant space of the data belonging to the group i, namely y(rⁱ)={y(rⁱ₁), . . . , y(rⁱ_{N})} (in the formula, N represents the number of the data belonging to the group i), and g(a,b) represents a function of calculating a distance between a and b in the discriminant space. Further, as the distance, it is possible to use, for example, a Mahalanobis' generalized distance and a Euclidean distance. One with the shortest distance of the m (i=1, . . . , M) is identified, and the type included in the group i corresponding to the one with the shortest distance is identified as the type H of the measurement target X.

H=argᵢ min mⁱ

As described hereinabove, since in the present process “3A,” the spectral information Sₛₐₘ, namely the spectroscopic information, is used as the feature amount for identifying the measurement target X, and the identification of the measurement target X is performed based on the shape of the spectral information sₛₐₘ, when “the measurement target X is similar to the pattern of the background,” the measurement target X can accurately be identified even when the measurement target and the background are the same in color type such as when identifying a “matsutake mushroom” located in withered pine needles, a “green caterpillar” located on a leaf, a “right-eyed or left-eyed flounder” located on a sand beach, a “stag beetle” or a “beetle” located on a tree branch as the measurement target X. Further, since the shape information is not used as the feature amount, even when “the measurement target X faces frontward or rearward in the imaged area” or when “the measurement target X fails to fall within the imaged area,” it is possible to accurately identify the measurement target X.

### 4A

Subsequently, the display control section 605 forms the information of the measurement target X identified by the analysis processing section 604 as a visualized image, and then make the display 70 provided with the display section 15 display (S7A) the visualized image.

The information of the measurement target X to be displayed by the display 70 as the visualized image, there can be cited, for example, the detailed information of the measurement target X such as the classification, a distribution, a form, and the biology besides the type of the measurement target X thus identified, namely the group H to which the measurement target X belongs, when the measurement target X is a creature such as a fish, a shellfish, an insect, or a mammal, or a plant such as a flower or a tree.

It should be noted that although the information stored in the storage section 17 is displayed by the display 70, it is also possible to make the display 70 display information disclosed on the Internet using a communication function of the smartphone 1.

By undergoing the process “1A” through the process “4A” using the smartphone 1 as the electronic pictorial book as described above, the identification of the measurement target X is performed.

It should be noted that although the spectroscopic process of comparing the dispersion spectrum as the spectroscopic information and the database stored in the storage section 17 to each other is described above with respect to when performing the spectroscopic process using the distances m (i=1, . . . , M) in the discriminant space, this is not a limitation, and the analytical process described above can also be arranged to be performed by machine learning such as a neural network.

Further, the identification of the measurement target X using the smartphone 1 as the electronic pictorial book can be applied to the identification of a creature or a plant as described above, and in addition, can also be applied to the identification of, for example, amineral such as a jewel, a vehicle such as an electric train or a car, a cloud, and a constellation.

### (2) Usage as Detection Device

A detection method of detecting presence or absence and a position of existence of a creature or a plant as the measurement target X (the object) the existence of which is required to be identified using the smartphone 1 described above as a detection device will hereinafter be described in detail using FIG. 9 and so on.

In the detection method using the smartphone 1 as the detection device, an area where the measurement target X, namely the detection target, is assumed to be located is imaged using the spectroscopic measurement section 10, and then the presence or absence, the position of existence, a probability (%) of existence, and so on of the measurement target X in the imaged area thus imaged are identified based on the spectral image thus taken. Subsequently, the content thus identified is displayed in the display 70.

### 1B

Firstly, the user operates the input section 16 to start up the application for using the smartphone 1 as the detection device, and then performs (S1B) selection of the condition and so on in accordance with the instruction by the application.

It should be noted that as the condition to be input in accordance with the instruction by the application, there can be cited a type or the like of the measurement target X desired to be detected in the image thus taken. Since it is possible to preferentially obtain the wavelength region in which the presence or absence of the existence of the measurement target X in the imaged area thus imaged can be identified due to such input of the type of the measurement target X to be detected, the detection of the measurement target X in the imaged area thus imaged can promptly be performed by the smartphone 1, the detail of which will be described later.

### 2B

Subsequently, the user operates the input section 16 to make the input instruction of imaging the area where the measurement target X is assumed to be detected using the smartphone 1, namely the spectroscopic measurement section 10. Then, based on this input instruction, the control section 60 controls the operation of the spectroscopic measurement section 10 to perform imaging of the imaged area where the measurement target X is assumed to be detected in the specific wavelength.

### 2B-1

Firstly, the light source control section 601 lights (S2B) the light source 31 in accordance with the input instruction of imaging by the user in the input section 16.

By lighting the light source 31, the imaged area where the measurement target X is assumed to be detected is irradiated with the illumination light emitted from the light source 31. Then, the light with which the imaged area is irradiated is reflected by the imaged area, and the light thus reflected enters the spectroscopic section 41 as the incident light.

### 2B-2

Subsequently, the spectroscopic control section 602 obtains the voltage value (the input value) of the drive voltage corresponding to the spectral wavelength, namely the specific wavelength, to be emitted based on the V-λ data stored in the storage section 17. Further, the spectroscopic control section 602 outputs (S3B) the command signal for applying the voltage value thus obtained to the electrostatic actuator 45 of the Fabry-Perot etalon filter as the spectroscopic section 41.

Thus, the light having the specific wavelength is selectively emitted as the outgoing light toward the imaging element 21 out of the light having entered the spectroscopic section 41 as the incident light from the measurement target X.

It should be noted that it is preferable for the spectroscopic control section 602 to perform an adjustment process of performing a calibration of the spectroscopic section 41 before making the spectroscopic section 41 emit the light having the specific wavelength. Thus, the dispersion spectrum s_{ref} of the light source 31 is obtained.

### 2B-3

Subsequently, the image acquisition section 603 controls the operation of the imaging element 21 to thereby obtain the light having the specific wavelength emitted as the outgoing light from the spectroscopic section 41 as the spectral image using the imaging element 21. In other words, the image acquisition section 603 obtains the light intensity measurement data (the intensity of the light received) in the light having the specific wavelength as the spectral image out of the reflected light reflected by the measurement target X using the imaging element 21. Then, the image acquisition section 603 stores (S4B) the spectral image thus obtained in the storage section 17 together with the measurement wavelength corresponding to the spectral image, namely the specific wavelength.

In such an acquisition method of the spectral image, the spectroscopic section 41 is disposed on the optical axis of the received light by the imaging element 21 between the imaged area where the measurement target X is assumed to be detected and the imaging element 21. Thus, only the light having the specific wavelength provided to the light reflected by the imaged area described above is transmitted by the spectroscopic section 41, and the intensity of the light in the specific wavelength is spectroscopically measured by the imaging element 21 as the spectral image.

### 2B-4

Subsequently, after obtaining the spectral image in the light having the first specific wavelength, whether or not the acquisition of the spectral image in the light having the second specific wavelength different from the first specific wavelength is necessary is determined based on the condition selected by the user and so on in the process “1B” described above. In other words, whether or not it is necessary to subsequently obtain the spectral image in the light having the second specific wavelength different from the first specific wavelength is determined (S5B).

In this determination (S5B), when it is necessary to obtain the spectral image in the light having the second specific wavelength, the process “2B-2” described above through the present process “2B-4” are repeatedly performed with respect to the light having the second specific wavelength instead of the light having the first specific wavelength. In other words, the magnitude of the voltage to be applied between the stationary electrode 412 and the movable electrode 422 of the electrostatic actuator 45 is changed to a value corresponding to the second specific wavelength, and then the process “2B-2” described above through the present process “2B-4” are repeatedly performed. Thus, the spectral image in the light having the second specific wavelength is obtained. The acquisition of the spectral image in the light having such a second specific wavelength, namely the different specific wavelength, is repeatedly performed at the first time, the second time through the n-th time. As described above, by repeatedly perform the process “2B-2” described above through the present process “2B-4,” it is possible to obtain the spectroscopic information as the spectral information sₛₐₘ representing the relationship between each of the specific wavelengths and the light intensity corresponding to each of the pixels in the imaged area where the measurement target X is assumed to be detected.

In other words, in FIG. 8, the spectral information Sₛₐₘ is represented as the graph showing the relationship between each of the specific wavelengths obtained by dividing the wavelength region no less than 400 nm and no more than 760 nm as the wavelength region of the visible light into n parts and the light intensity, and the graph, namely the spectral information, is obtained as the total spectroscopic information in the imaged area provided to each of the M×N pixels as a result.

In contrast, when it is not necessary to obtain the spectral image in the light having the next wavelength, the acquisition of the spectral image by the spectroscopic measurement section 10 is terminated, and the transition to the next process “3B” is made.

### 3B

Subsequently, the analysis processing section 604 performs (S6B) the analysis of the spectral image based on the spectral images and the specific wavelengths of the measurement target X, namely based on the spectral information sₛₐₘ, stored in the storage section 17.

In other words, the analysis processing section 604 obtains the spectral information sₛₐₘ stored in the storage section 17 in the process “2B” described above. Then, by performing the analytical process using the spectral information sₛₐₘ as the feature amount having the spectroscopic information, the measurement target X as an object is detected from the imaged area imaged by the spectroscopic measurement section 10.

Specifically, the reflectance r=sₛₐₘ/s_{ref} in the imaged area where the measurement target X is assumed to be detected is calculated from the spectral information sₛₐₘ and the dispersion spectrum s_{ref} of the light source 31. Further, by dividing the imaged area into the M×N pixels, the data rⁱⱼ corresponding to the respective regions (i=1, . . . , M), (j=1, . . . , N) obtained by dividing the imaged area into M×N regions.

Then, the analysis processing section 604 obtains the reflectance r_{base} corresponding to the measurement target X out of the database prepared in advance in the storage section 17, and then determines whether or not the reflectance rⁱⱼ corresponding to each of the regions obtained by dividing the imaged area into M×N regions belongs to the reflectance r_{base} corresponding to the measurement target X to thereby identify the position where the measurement target X is located in the imaged area.

More specifically, firstly, a projection function f(⋅) on a discriminant space suitable to discriminate the groups is made based on a specific discriminant criterion. It should be noted that as the discriminant criterion, there can be cited, for example, a Fisher discriminant criterion and a least square criterion. Further, the reflectance r_{base} of the measurement target X stored in the database is projected on the discriminant space to be defined as y.

y=f(r_{base})

Similarly, the data rⁱⱼ corresponding to the respective regions (i=1, . . . , M), (j=1, . . . , N) obtained by dividing the imaged area into M×N regions are also projected on the discriminant space to be defined as y(rⁱⱼ). Then, distances mⁱ (i=1, . . . , M), (j=1, . . . , N) in the discriminant space between the measurement target X and the respective regions (i=1, . . . , M), (j=1, . . . , N) are calculated.

mⁱⱼ (i=1, . . . ,M), (j=1, . . . ,N)=g(y,y(rⁱⱼ))

Here, g( ) represents a function of calculating a distance in the discriminant space. Further, as the distance, it is possible to use, for example, a Mahalanobis' generalized distance and a Euclidean distance.

Further, when the distance mⁱⱼ (i=1, . . . , M), (j=1, . . . , N) is smaller than a predetermined threshold value, it is determined that there is a probability that the measurement target X exists in that region, namely it is determined that the measurement target X has been detected in that region, and by further breaking up the threshold value, it is possible to identify the existence probability (%) in that region.

As described hereinabove, since in the present process “3B,” the spectral information Sₛₐₘ, namely the spectroscopic information, is used as the feature amount for detecting the measurement target X, and the detection of the measurement target X in the imaged area is performed based on the shape of the spectral information Sₛₐₘ, when “the measurement target X is similar to the pattern of the background,” the measurement target X can accurately be detected from the imaged area even when the measurement target and the background are the same in color type such as when detecting a “matsutake mushroom” located in withered pine needles, a“green caterpillar” located on a leaf, a “right-eyed or left-eyed flounder” located on a sand beach, a “stag beetle” or a “beetle” located on a tree branch as the measurement target X. Further, since the shape information is not used as the feature amount, even when “the measurement target X faces frontward or rearward in the imaged area” or when “the measurement target X fails to fall within the imaged area,” it is possible to accurately detect the measurement target X.

### 4B

Subsequently, the display control section 605 forms a visualized image in which the region where the measurement target X is determined to be located is provided with, for example, red marking to thereby be highlighted out of the imaged area imaged by the spectroscopic measurement section 10 in the analysis processing section 604. Subsequently, as shown in FIG. 1, the display 70 provided with the display section 15 is made to display (S7B) the visualized image. It should be noted that in FIG. 1, on the display section 15, the position where an insect such as a beetle or a stag beetle as the measurement target X sits on a tree is identified by highlighting with marking.

It should be noted that in the visualized image, besides the marking on the region where the measurement target X is determined to exist, it is also possible to, for example, display the existence probability (%) of the existence of the measurement target X in the vicinity of the marking, and further change the color of the marking in accordance with the existence probability (%) of the existence of the measurement target X.

By undergoing the process “1B” through the process “4B” using the smartphone 1 as a detection device described above, it is possible to detect presence or absence of the measurement target X and the position where the measurement target X exists in the imaged area where the measurement target X is assumed to be located.

It should be noted that the detection of the measurement target X in the imaged area using the smartphone 1 as the detection device can be applied to the detection of a creature or a plant as described above, and in addition, can also be applied to the detection of, for example, a mineral such as a jewel, a cloud, and a constellation.

### (3) Usage as Appraisal Device

The appraisal method of appraising the authenticity and the degree of aged deterioration of an article such as a bag, a wallet, a watch, or a jewel as the measurement target X using the smartphone 1 described above as an appraisal device will hereinafter be described in detail using FIG. 10 and so on.

In the appraisal method using the smartphone 1 as the appraisal device, the measurement target X to be appraised is imaged using the spectroscopic measurement section 10, and the appraisal of the authenticity, or the degree of aged deterioration of the measurement target X is performed based on the spectral image thus taken. Subsequently, the content thus appraised is displayed in the display 70.

### 1C

Firstly, the user operates the input section 16 to start up the application for using the smartphone 1 as the appraisal device, and then performs (S1C) selection of the condition and so on as needed in accordance with the instruction by the application.

It should be noted that as the condition to be input in accordance with the instruction by the application, there can be cited a type of the measurement target X, namely the article, to be appraised, in other words, a product number of the measurement target X, and a type of the appraisal of the authenticity, or the degree of aged deterioration. The determination of the authenticity or the degree of aged deterioration of the measurement target X in the imaged area imaged by the smartphone 1 can promptly be performed by inputting in advance the product number of the measurement target X to be appraised as described above, the details of which will be described later.

### 2C

Subsequently, the user operates the input section 16 to make an input instruction of imaging the measurement target X with the smartphone 1, namely the spectroscopic measurement section 10, and then, the control section 60 controls the operation of the spectroscopic measurement section 10 to perform imaging of the measurement target X in the specific wavelength based on the input instruction.

### 2C-1

Firstly, the light source control section 601 lights (S2C) the light source 31 in accordance with the input instruction of imaging the measurement target X by the user in the input section 16.

By lighting the light source 31, the measurement target X is irradiated with the illumination light emitted from the light source 31. Then, the light with which the measurement target X is irradiated is reflected by the measurement target X, and the light thus reflected enters the spectroscopic section 41 as the incident light.

### 2C-2

Subsequently, the spectroscopic control section 602 obtains the voltage value (the input value) of the drive voltage corresponding to the spectral wavelength, namely the specific wavelength, to be emitted based on the V-λ data stored in the storage section 17. Further, the spectroscopic control section 602 outputs (S3C) the command signal for applying the voltage value thus obtained to the electrostatic actuator 45 of the Fabry-Perot etalon filter as the spectroscopic section 41.

Thus, the light having the specific wavelength is selectively emitted as the outgoing light toward the imaging element 21 out of the light having entered the spectroscopic section 41 as the incident light from the measurement target X.

It should be noted that it is preferable for the spectroscopic control section 602 to perform an adjustment process of performing a calibration of the spectroscopic section 41 before making the spectroscopic section 41 emit the light having the specific wavelength. Thus, the dispersion spectrum s_{ref} of the light source 31 is obtained.

### 2C-3

Subsequently, the image acquisition section 603 controls the operation of the imaging element 21 to thereby obtain the light having the specific wavelength emitted as the outgoing light from the spectroscopic section 41 as the spectral image using the imaging element 21. In other words, the image acquisition section 603 obtains the light intensity measurement data (the intensity of the light received) in the light having the specific wavelength as the spectral image out of the reflected light reflected by the measurement target X using the imaging element 21. Then, the image acquisition section 603 stores (S4C) the spectral image thus obtained in the storage section 17 together with the measurement wavelength corresponding to the spectral image, namely the specific wavelength.

In such an acquisition method of the spectral image, the spectroscopic section 41 is disposed on the optical axis of the received light by the imaging element 21 between the measurement target X and the imaging element 21. Thus, only the light having the specific wavelength provided to the light reflected by the measurement target X is transmitted through the spectroscopic section 41, and the intensity of the light in the specific wavelength is spectroscopically measured by the imaging element 21 as the spectral image.

### 2C-4

Subsequently, after obtaining the spectral image in the light having the first specific wavelength, whether or not the acquisition of the spectral image in the light having the second specific wavelength different from the first specific wavelength is necessary is determined based on the condition selected by the user and so on in the process “1C” described above. In other words, whether or not it is necessary to subsequently obtain the spectral image in the light having the second specific wavelength different from the first specific wavelength is determined (S5C).

In this determination (S5C), when it is necessary to obtain the spectral image in the light having the second specific wavelength, the process “2C-2” described above through the present process “2C-4” are repeatedly performed with respect to the light having the second specific wavelength instead of the light having the first specific wavelength. In other words, the voltage value to be applied between the stationary electrode 412 and the movable electrode 422 of the electrostatic actuator 45 is changed to a value corresponding to the second specific wavelength, and then the process “2C-2” described above through the present process “2C-4” are repeatedly performed. Thus, the spectral image in the light having the second specific wavelength is obtained. The acquisition of the spectral image in the light having such a second specific wavelength, namely the different specific wavelength, is repeatedly performed at the first time, the second time through the n-th time. As described above, by repeatedly perform the process “2C-2” described above through the present process “2C-4,” it is possible to obtain the spectroscopic information as the spectral information sₛₐₘ representing the relationship between each of the specific wavelengths and the light intensity corresponding to each of the pixels included in the spectral image.

In other words, in FIG. 8, the spectral information Sₛₐₘ is represented as the graph showing the relationship between each of the specific wavelengths obtained by dividing the wavelength region no less than 400 nm and no more than 760 nm as the wavelength region of the visible light into n parts and the light intensity, and the graph, namely the spectral information, is obtained as the total spectroscopic information provided to each of the M×N pixels as a result.

In contrast, when it is not necessary to obtain the spectral image in the light having the next wavelength, the acquisition of the spectral image by the spectroscopic measurement section 10 is terminated, and the transition to the next process “3C” is made.

### 3C

Subsequently, the analysis processing section 604 performs (S6C) the analysis of the spectral image based on the spectral images and the specific wavelengths of the measurement target X, namely based on the spectral information sₛₐₘ, stored in the storage section 17.

In other words, the analysis processing section 604 obtains the spectral information sₛₐₘ stored in the storage section 17 in the process “2C” described above. Then, by performing the analytical process using the spectral information sₛₐₘ as the feature amount having the spectroscopic information, the appraisal of the measurement target X thus imaged is performed.

Specifically, the reflectance r=sₛₐₘ/s_{ref} of the measurement target X is calculated from the spectral information sₛₐₘ and the dispersion spectrum s_{ref} of the light source 31.

Then, by obtaining the reflectance r corresponding to an authentic product (i=x) of the measurement target X out of the data rⁱ corresponding to the group i=1, . . . , M stored in advance in the storage section 17, and then determining whether or not the reflectance r of the measurement target X is equivalent to the reflectance rⁱ of the authentic product using the reflectance rⁱ, the analysis processing section 604 appraises the measurement target X.

More specifically, firstly, a projection function f(⋅) on a discriminant space suitable to discriminate the groups is made based on a specific discriminant criterion. It should be noted that as the discriminant criterion, there can be cited, for example, a Fisher discriminant criterion and a least square criterion.

Further, when the type of the appraisal is the authenticity of the article, the reflectance r of the measurement target X is projected on the discriminant space to be defined as y.

y=f(r)

Similarly, the data rⁱ of the authentic product (i=x) as a brand-new product is also projected on the discriminant space to be defined as y(rⁱ). Then, distance m (i=x) in the discriminant space between a position y on the discriminant space of the measurement target X and the authentic product (i=x) is calculated.

mⁱ (i=x)=g(y,y(rⁱ))

Here, g( ) represents a function of calculating a distance in the discriminant space. Further, as the distance, it is possible to use, for example, a Mahalanobis' generalized distance and a Euclidean distance.

Then, when the length of the distance mⁱ (i=x) is shorter than a predetermined threshold value, it is determined that the measurement target is the authentic product, and by further breaking up the threshold value, it is possible to identify the probability (%) that the measurement target X is the authentic product.

Further, when the type of the appraisal is the degree of aged deterioration of the article, the reflectance r of the measurement target X is projected on the discriminant space to be defined as y.

y=f(r)

Similarly, the data rⁱ of the authentic product (i=1, . . . , M) obtained for the respective degrees of aged deterioration are also projected on the discriminant space to be defined as y(rⁱ). Then, distances m (i=1, . . . , M) in the discriminant space between the position y on the discriminant space of the measurement target X and the authentic products (i=1, . . . , M) corresponding respectively to the degrees of deterioration are calculated.

mⁱ (i=1, . . . ,M)=g(y,y(rⁱ))

Here, y(rⁱ) represents an aggregate of the positions on the discriminant space of the data belonging to the authentic products, namely y(rⁱ)={y(rⁱ₁), . . . , y(rⁱ_{N})} (in the formula, N represents the number of the data belonging to the group i), and g(a,b) represents a function of calculating a distance between a and b in the discriminant space. Further, as the distance, it is possible to use, for example, a Mahalanobis' generalized distance and a Euclidean distance.

Further, when the length of the distance mⁱ (i=1, . . . , M) is shorter than the predetermined threshold value, it is possible to appraise that the degree of aged deterioration of the measurement target is the degree designated by the group i to which the measurement target belongs.

### 4C

Subsequently, the display control section 605 forms the information of the measurement target X identified by the analysis processing section 604 as a visualized image, and then make the display 70 provided with the display section 15 display (S7C) the visualized image.

In the visualized image, besides the image of the measurement target X on which the appraisal has been performed, there are displayed the determination result on whether or not the measurement target X is the authentic product, and further, the information such as the probability (%) that the measurement target X is the authentic product when the classification of the appraisal is the authenticity of the measurement target X, and there are displayed the degree (%) of deterioration of the measurement target X, and further, the information such as an appraisal value based on the degree of deterioration when the classification of the appraisal is the degree of aged deterioration of the measurement target X. It should be noted that when the classification of the appraisal is the authenticity of the measurement target X, it is also possible to arrange that the transition to the appraisal of the degree of aged deterioration of the measurement target X is automatically made when the appraisal result that the measurement target X is the authentic product has been obtained by the present appraisal.

By undergoing the process “1C” through the process “4C” using the smartphone 1 as the appraisal device as described above, the appraisal of the measurement target X is performed.

It should be noted that the appraisal of the measurement target X using the smartphone 1 as the appraisal device can be applied to the article such as a bag, a wallet, a watch, or a jewel described above, and in addition, can also be applied to the identification of a creature, a plant, a cloud, a constellation, and so on when using the appraisal device for the authenticity of the measurement target X.

Further, although in the present embodiment, there is described when performing the identification of the measurement target X using the reflectance of the measurement target X as the spectroscopic information, this is not a limitation, and it is also possible to perform the identification of the measurement target X when using, for example, the transmittance, the absorbance, or Kubelka-Munk conversion data of the measurement target X as the spectroscopic information.

Further, although in the present embodiment, there is described when the spectroscopic measurement section 10 is provided with the light source 31, the spectroscopic section 41, and the imaging element 21 as the spectroscopic camera, it is possible to eliminate the light source 31 out of these constituents from the spectroscopic measurement section 10. In this case, in the spectroscopic measurement section 10, the irradiation of the measurement target X with the light is performed using the outside light such as sunlight or room illumination in the processes “2A,” “2B,” and “2C” described above for taking the spectral image with the spectroscopic measurement section 10.

Further, although in the present embodiment, the description is presented using the smartphone 1 as an example assuming that the information system according to the present disclosure is completed with an information terminal alone, such an information terminal is not limited to the smartphone 1, and can also be, for example, a tablet terminal, a laptop computer, a digital camera, a digital video camera, an in-vehicle monitor, or a drive recorder. It should be noted that by making the information system according to the present disclosure have a configuration completed with the information terminal alone as in the present embodiment, it is possible to realize the off-line use, and therefore, the information system becomes available even in a place where the communication situation is unstable.

Further, although in the present embodiment, there is described when the input section 16 is formed of the touch panel, this is not a limitation, and the input section 16 can be an operating button provided to the housing of the smartphone 1, or a device in which the input is performed with a voice via a microphone provided to the smartphone 1, or can also be a combination thereof.

Here, as described above, in order to obtain the spectroscopic information, namely the spectral information Sₛₐₘ, using the spectroscopic camera, namely the spectroscopic measurement section 10, it is necessary to perform the acquisition of the spectral image in the light having different specific wavelength or the different specific wavelength region by repeating (1) the process “2A-2” described above through the process “2A-4” described above when using the information system as the electronic pictorial book for identifying the type of the measurement target X, (2) the process “2B-2” described above through the process “2B-4” described above when using the information system as the detection device for detecting the measurement target X from the imaged area thus imaged, or (3) the process “2C-2” described above through the process “2C-4” described above when using the information system as the appraisal device for appraising the article as the measurement target X up to n times as shown in FIG. 8, and further superimpose the spectral images in the n divisional regions thus obtained on each other. Therefore, it takes time to obtain the spectroscopic information, namely the spectral information sₛₐₘ.

Further, in these cases, in order to make the measurement target X fall within the image to be obtained by the spectroscopic camera, namely the spectroscopic measurement section 10, a picture assuming the image to be taken is sequentially displayed in the display section 15 provided to the smartphone 1 in the standby state prior to taking the image.

Therefore, when using the spectroscopic information, namely the spectral information sₛₐₘ, obtained by the spectroscopic measurement section 10 as the image, firstly, the spectral information sₛₐₘ is converted into the tristimulus values specified in International Commission on Illumination CIE, namely the X, Y, and Z values. Then, by converting the X, Y, and Z values are into the R, G, and B values using a monitor profile, and then supplying the result to the display section 15, the image of the measurement target X is displayed on the display section 15, and further, by repeatedly performing the process of displaying the image, the picture is displayed on the display section 15.

However, as described above, in the display method of forming an image to be displayed on the display section 15 by conversing the spectral information sₛₐₘ into the X, Y, and Z values and then the R, G, and B values, since it takes time to obtain the spectral information sₛₐₘ, there arises the problem that dropping frames occurs in the picture to be displayed using the images.

In contrast, in the present embodiment, the smartphone 1 has the second camera formed of the RGB camera for obtaining the second image of the measurement target X different from the spectral image as the RGB image in addition to the first camera as the spectroscopic camera, namely the spectroscopic measurement section 10.

The RGB camera as the second camera has an RGB image acquisition section including an imaging element 22, and is configured so as to be able to obtain the RGB image with single imaging by the imaging element 22 receiving the reflected light reflected by the measurement target X.

Therefore, since it does not take time to obtain the RGB image, by adopting the display method of performing the conversion to the X, Y, and Z values and then the R, G, and B values based on the RGB image to thereby form the image to be displayed on the display section 15, it is possible to accurately inhibiting or preventing the dropping frames from occurring in the picture to be displayed based on the images in the standby period prior to obtaining the image using the spectroscopic camera.

Therefore, the display method of displaying the picture on the display section 15 during the standby period described above based on the RGB image will hereinafter be described.

### Display Method in Standby Period

Using FIG. 11 and so on, there will hereinafter be described in detail the display method for displaying the picture on the display section 15 in the standby period when obtaining the inherent spectroscopic information provided to the measurement target X as the first image using the smartphone 1, and having an imaging process of imaging the spectroscopic information as the first image and imaging the RGB image of the measurement target X different from the spectroscopic information as the second image, and a display process of inevitably displaying the second image and selectively displaying the first image on the display section 15 out of the first image and the second image.

### 1D

Firstly, in the usage as (1) the electronic pictorial book, (2) the detection device, or (3) the appraisal device described above, the control section 60 controls the operation of the spectroscopic camera as the first camera, namely the spectroscopic measurement section 10, to obtain the spectroscopic information of the measurement target X to thereby perform imaging of the first image based on the input instruction in the input section 16 input by the user.

Then, in tandem with the imaging of the first image with the spectroscopic camera, the control section 60 controls the operation of the RGB camera as the second camera, namely an RGB image acquisition section, to perform (an imaging process; S1D) the imaging of the RGB image, namely the second image, of the measurement target X.

It is configured that the acquisition of the RGB image by the RGB camera, namely the RGB image acquisition section, can be achieved by single imaging with the imaging element 22 provided to the RGB image acquisition section. Therefore, there is an advantage that it does not take time to obtain the RGB image.

Further, the spectroscopic information, namely the first image, obtained in the spectroscopic measurement section 10 can be the spectral information sₛₐₘ obtained by superimposing the n spectral images on each other, but it is preferable to obtain one of the n spectral images shown in FIG. 8, namely the spectral image obtained in one of the wavelength regions obtained by dividing the whole wavelength region into n parts, or the spectral image obtained in the wavelength as the initial value or the shortest wavelength of the wavelength regions obtained by dividing the whole wavelength region into n parts as the spectroscopic information. Thus, the amount of the information used when obtaining the spectroscopic information, namely the first image, obtained by the spectroscopic measurement section 10 decreases. Therefore, it is possible to achieve reduction in time when obtaining the first image.

### 2D

Subsequently, the display control section 605 inevitably displays (a display process; S2D) the second image, and selectively displays the first image on the display section 15 out of the spectroscopic information, namely the first image, and the RGB image, namely the second image, obtained in the process “1D” described above.

Here, when the second image is displayed and the display of the first image is omitted in the display section 15, it is preferable for the display control section 605 to display the second image alone in substantially the entire surface of the display section 15, and the display of the second image is performed by converting the RGB image into the tristimulus values, namely the X, Y, and Z values, then converting the X, Y, and Z values into the R, G, and B values using the monitor profile, and then supplying the result to the display section 15. Since it does not take time to obtain the RGB image in the process “1D” described above, the display of the RGB image, namely the second image, in the display section 15 in the present process “2D” can promptly be performed. Therefore, it is possible to accurately inhibit or prevent the dropping frames from occurring in the picture to be displayed based on the images.

In contrast, when displaying both of the first image and the second image in the display section 15, it is preferable for the display control section 605 to individually display the first image and the second image in the respective areas different from each other in substantially the entire surface of the display section 15. Alternatively, it is preferable to display the first image and the second image in a superimposed manner in the respective areas overlapping each other.

Here, when displaying the first image and the second image in a superimposed manner, the first image is displayed on the display section 15 by converting the spectroscopic information, namely the spectral information sₛₐₘ into the tristimulus values, namely the X, Y, and Z values, then converting the X, Y, and Z values into the R, G, and B values using the monitor profile, and then supplying the result to the display section 15. Therefore, as described above, it take time perform the display. However, display of the second image is performed promptly as described above. Therefore, by repeatedly performing the display of the first image and the second image, it is possible to accurately inhibit or prevent the dropping frames based on the first image from being conspicuously displayed on the display section 15 by displaying the second image even when displaying the pictures on the display section 15.

Further, when displaying the first image and the second image separately from each other, it takes time to display the first image as described above, but the display of the second image is performed promptly. Therefore, by repeatedly performing the display of the first image and the second image, the dropping frames occurs in the picture based on the first image, but does not occur in the picture based on the second image when making the display section 15 display these pictures separately from each other. Therefore, since the user views the picture based on the second image, it is possible for the user to check the picture displayed by the display section 15 without stress.

### 3D

Subsequently, after the display by the display section 15 in the process “2D” described above in which the second image is inevitably displayed and the first image is selectively displayed, the display control section 605 determines (S3D) presence or absence of the instruction of the image acquisition with the first camera, namely the spectroscopic camera, by the user, in other words, whether or not the shutter of the spectroscopic camera has been pressed.

When the shutter of the spectroscopic camera has not been pressed by the user in this determination (S3D), the process “1D” described above and the process “2D” described above are repeatedly executed. Thus, the display of the picture in which the second image is inevitably displayed and the first image is selectively displayed is continuously performed in the display section 15.

In contrast, when the shutter of the spectroscopic camera is pressed by the user, the display of the picture on the display section 15 is stopped, and the transition to the imaging by the spectroscopic camera, namely the spectroscopic measurement section 10, in the usage as (1) the electronic pictorial book, (2) the detection device, or (3) the appraisal device described above is made to terminate the display of the picture in the display section 15 in the standby state.

It should be noted that even when displaying the second image on the display section 15 and omitting the display of the first image in the process “2D” described above, it is assumed in the present embodiment that the control section 60 controls the operation of the spectroscopic measurement section 10 to perform imaging of the first image in the process “1D” described above, but this is not a limitation, and it is possible to omit the imaging of the first image due to the operation of the spectroscopic measurement section 10 in the process “1D” described above. Further, when the imaging of the first image in the process “1D” described above is omitted as described above, it is sufficient to arrange that the spectroscopic measurement section 10 is operated at the moment when the shutter of the spectroscopic camera is pressed by the user in the present process “3D.”

By undergoing such processes “1D” through “3D” as described hereinabove, the display of the picture on the display section 15 when setting the spectroscopic camera in the standby state is performed.

It should be noted that although in the present embodiment, there is described when preparing the RGB camera as the second camera, and thus, obtaining the RGB image as the second image, this is not a limitation, and it is also possible to arrange that a black-and-white camera or an XYZ camera is prepared as the second camera, and thus, a black-and-white image or an XYZ image is obtained as the second image.

### Second Embodiment

Then, a second embodiment as the information system according to the present disclosure will be described.

FIG. 12 is a block diagram showing a schematic configuration of a smartphone and a spectroscopic measurement section to which the second embodiment as the information system according to the present disclosure is applied.

Hereinafter, the information system as the second embodiment will be described with a focus mainly on the differences from the information system as the first embodiment described above, and the descriptions regarding substantially the same matters will be omitted.

The information system as the second embodiment shown in FIG. 12 is substantially the same as the information system as the first embodiment described above except the point that the spectroscopic measurement section 10 is further provided independently of the smartphone 1 as the information terminal, and the spectroscopic measurement section 10 exerts the function as the spectroscopic camera. In other words, in the information system as the second embodiment, the information system according to the present disclosure is not completed with the smartphone 1 alone as the information terminal, but has the smartphone 1 as the information terminal and the spectroscopic measurement section 10 as the spectroscopic camera.

In the information system as the second embodiment, as shown in FIG. 12, the spectroscopic measurement section 10 is omitted from the inside of the smartphone 1, but is independently disposed outside the smartphone 1 instead as the spectroscopic camera, and is configured so that the operation thereof can be controlled by the smartphone 1. It should be noted that the control of the spectroscopic measurement section 10 by the smartphone 1 with the electrical coupling between the smartphone 1 and the spectroscopic measurement section 10 can be performed with wire or wirelessly.

In the information system as the second embodiment having such a configuration, the acquisition of the image including the measurement target X by the spectroscopic measurement section 10 and the operation such as setting of the condition for identifying the measurement target X by the smartphone 1 can be executed independently of each other. Therefore, it is possible to achieve an improvement in operability of the information system.

Further, the information system according to the present disclosure can be used by installing an application in the smartphone 1, and at the same time, coupling the spectroscopic measurement section 10 to the smartphone 1, and therefore, it is possible to use the smartphone 1 not provided with the spectroscopic measurement section 10, and therefore, the information system is excellent in general versatility.

Further, by providing the information system according to the present disclosure with the configuration completed with the smartphone 1 and the spectroscopic measurement section 10, the information system can be used off-line except the communication between the smartphone 1 and the spectroscopic measurement section 10, and can therefore be used even in a place where the communication situation is unstable.

According also to such an information system as the second embodiment, substantially the same advantages as in the first embodiment can be obtained.

Further, although in the present embodiment, there is described when the information system according to the present disclosure has the smartphone 1 as the information terminal and the spectroscopic measurement section 10 as the spectroscopic camera, in the information system according to the present disclosure, the information terminal can be formed of a tablet terminal or the like instead of the smartphone 1, or the smartphone 1, namely the information terminal, can be constituted by a server or the like.

### Third Embodiment

Then, a third embodiment as the information system according to the present disclosure will be described.

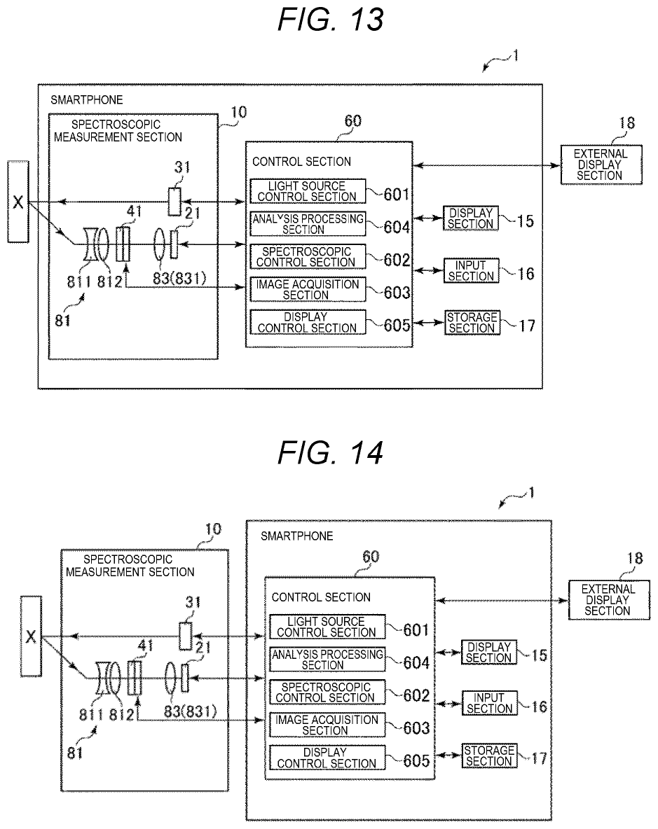

FIG. 13 is a block diagram showing a schematic configuration of a smartphone and an external display section to which the third embodiment as the information system according to the present disclosure is applied.

Hereinafter, the information system as the third embodiment will be described with a focus mainly on the differences from the information system as the first embodiment described above, and the descriptions regarding substantially the same matters will be omitted.

The information system as the third embodiment shown in FIG. 13 is substantially the same as the information system as the first embodiment described above except the point that an external display section 18 is further provided independently of the smartphone 1 as the information terminal, and the external display section 18 exerts the function as the display section outside the smartphone 1. In other words, in the information system as the third embodiment, the information system according to the present disclosure is not completed with the smartphone 1 alone as the information terminal, but has the smartphone 1 as the information terminal and the external display section 18.

As shown in FIG. 13, the information system as the third embodiment is further provided with the external display section 18 disposed independently outside the smartphone 1 in addition to the display section 15 provided to the smartphone 1, and has a configuration in which the operation of the external display section 18 can be controlled by the smartphone 1. It should be noted that the control of the external display section 18 by the smartphone 1 with the electrical coupling between the smartphone 1 and the external display section 18 can be performed with wire or wirelessly.

In the information system as the third embodiment having such a configuration, the confirmation of the image by the operator in the external display section 18 and the operation such as setting of the condition for identifying the measurement target X by the smartphone 1 can be executed independently of each other, and therefore, it is possible to achieve an improvement in operability of the information system.

Further, by providing the information system according to the present disclosure with the configuration completed with the smartphone 1 and the external display section 18, the information system can be used off-line except the communication between the smartphone 1 and the external display section 18, and can therefore be used even in a place where the communication situation is unstable.

Further, as the external display section 18, there can be cited a mobile notebook PC, a tablet terminal, a head-up display (HUD), a head-mounted display (HMD), and so on, and among these devices, the head-mounted display is preferable. According to the head-mounted display, it is possible to display, for example, the result of the identification of the measurement target X, and the position where the measurement target X is assumed to be located in the augmented reality (AR), and further, it is possible to achieve a further improvement in operability of the information system since the hands-free use is available.

According also to such an information system as the third embodiment, substantially the same advantages as in the first embodiment can be obtained.

### Fourth Embodiment

Then, a fourth embodiment as the information system according to the present disclosure will be described.

FIG. 14 is a block diagram showing a schematic configuration of a smartphone, a spectroscopic measurement section, and an external display section to which the fourth embodiment as the information system according to the present disclosure is applied.

Hereinafter, the information system as the fourth embodiment will be described with a focus mainly on the differences from the information system as the first embodiment described above, and the descriptions regarding substantially the same matters will be omitted.

The information system as the fourth embodiment shown in FIG. 14 is substantially the same as the information system as the first embodiment described above except the point that the spectroscopic measurement section 10 and the external display section 18 are further provided independently of the smartphone 1 as the information terminal, the spectroscopic measurement section 10 exerts the function as the spectroscopic camera, and the external display section 18 exerts the function as the display section outside the smartphone 1. In other words, in the information system as the fourth embodiment, the information system according to the present disclosure is not completed with the smartphone 1 alone as the information terminal, but has the smartphone 1 as the information terminal, the spectroscopic measurement section 10, and the external display section 18.

In the information system as the fourth embodiment, as shown in FIG. 14, the spectroscopic measurement section 10 is omitted from the inside of the smartphone 1, but is independently disposed outside the smartphone 1 instead as the spectroscopic camera, and is configured so that the operation thereof can be controlled by the smartphone 1. Further, the information system is further provided with the external display section 18 disposed independently outside the smartphone 1 in addition to the display section 15 provided to the smartphone 1, and has a configuration in which the operation of the external display section 18 can be controlled by the smartphone 1.

It should be noted that the control of the spectroscopic measurement section 10 by the smartphone 1 with the electrical coupling between the smartphone 1 and the spectroscopic measurement section 10, and the control of the external display section 18 by the smartphone 1 with the electrical coupling between the smartphone 1 and the external display section 18 can each be performed with wire or wirelessly.

In the information system as the fourth embodiment having such a configuration, the acquisition of the image including the measurement target X by the spectroscopic measurement section 10, the confirmation of the image by the operator in the external display section 18, and the operation such as setting of the condition for identifying the measurement target X by the smartphone 1 can be executed independently of each other, and therefore, it is possible to achieve an improvement in operability of the information system.

Further, the information system according to the present disclosure can be used by installing an application in the smartphone 1, and at the same time, coupling the spectroscopic measurement section 10 and the external display section 18 to the smartphone 1, and therefore, it is possible to use the smartphone 1 not provided with the spectroscopic measurement section 10, and therefore, the information system is excellent in general versatility.

Further, by providing the information system according to the present disclosure with the configuration completed with the smartphone 1, the spectroscopic measurement section 10, and the external display section 18, the information system can be used off-line except the communication between the smartphone 1, and the spectroscopic measurement section 10 and the external display section 18, and can therefore be used even in a place where the communication situation is unstable.

Further, as the external display section 18, there can be cited a mobile notebook PC, a tablet terminal, a head-up display (HUD), a head-mounted display (HMD), and so on, and among these devices, the head-mounted display is preferable. According to the head-mounted display, it is possible to display, for example, the result of the identification of the measurement target X, and the position where the measurement target X is assumed to be located in the augmented reality (AR), and further, it is possible to achieve a further improvement in operability of the information system since the hands-free use is available.

According also to such an information system as the fourth embodiment, substantially the same advantages as in the first embodiment can be obtained.

Further, although in the present embodiment, there is described when the information system according to the present disclosure has the smartphone 1 as the information terminal, the spectroscopic measurement section 10 as the spectroscopic camera, and the external display section 18 such as a head-mounted display, the information system according to the present disclosure can be provided with a tablet terminal or the like as the information terminal instead of the smartphone 1, or can be provided with a server or the like instead of the smartphone 1, namely the information terminal.

Further, although in the present embodiment, there is described when the spectroscopic measurement section 10 and the external display section 18 are independently provided as separated bodies as shown in FIG. 14, this is not a limitation, and it is also possible for the spectroscopic measurement section 10 and the external display section 18 to be formed integrally with each other.

### Fifth Embodiment

Then, a fifth embodiment as the information system according to the present disclosure will be described.

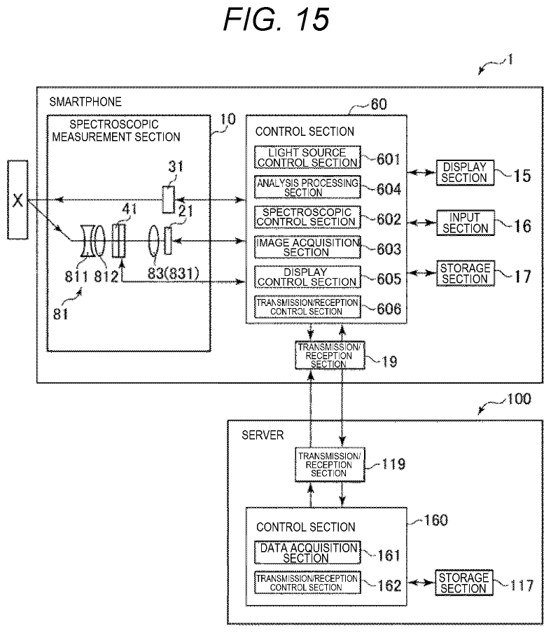

FIG. 15 is a block diagram showing a schematic configuration of a smartphone and a server to which the fifth embodiment as the information system according to the present disclosure is applied.

Hereinafter, the information system as the fifth embodiment will be described with a focus mainly on the differences from the information system as the first embodiment described above, and the descriptions regarding substantially the same matters will be omitted.

The information system as the fifth embodiment shown in FIG. 15 is substantially the same as the information system as the first embodiment described above except the point that a server 100 is further provided independently of the smartphone 1 as the information terminal. In other words, in the information system as the fifth embodiment, the information system according to the present disclosure is not completed with the smartphone 1 alone as the information terminal, but has the smartphone 1 as the information terminal and the server 100.

In the information system as the fifth embodiment, as shown in FIG. 15, the smartphone 1 further has a transmission/reception section 19, and further has a transmission/reception control section 606 for controlling the operation of the transmission/reception section 19 in the control section 60.

Further, the server 100 has a storage section 117, a transmission/reception section 119, and a control section 160, and the control section 160 has a data acquisition section 161 and a transmission/reception control section 162 for respectively controlling the operations of the storage section 117 and the transmission/reception section 119.

In such an information system as the present embodiment, in the storage section 17 provided to the smartphone 1, storage of the database for identifying the measurement target X is omitted, and the database is stored instead in the storage section 17 provided to the server 100.

Further, the transmission/reception section 19 provided to the smartphone 1 and the transmission/reception section 119 provided to the server 100 perform delivery of the database. Specifically, the transmission/reception section 19 transmits an acquisition request of the database from the storage section 117 to the transmission/reception section 119, and receives the database from the server 100 via the transmission/reception section 119. Further, the transmission/reception section 119 receives the acquisition request of the database from the storage section 117 by the transmission/reception section 19, and transmits the database to the smartphone 1 via the transmission/reception section 19. It should be noted that the delivery of the database between the transmission/reception section 19 and the transmission/reception section 119 can be performed with wire or wirelessly, and when performing the delivery wirelessly, it is possible to perform the delivery via the Internet.

Further, the transmission/reception control section 606 provided to the smartphone 1 in the control section 60 controls the operation of the transmission/reception section 19 to receive the database from the server 100 via the transmission/reception section 119, and the analysis processing section 604 receives the database from the transmission/reception control section 606, and then performs the identification of the measurement target X based on the database thus received.

Further, the data acquisition section 161 provided to the server 100 in the control section 160 obtains the database stored in the storage section 117 in accordance with the acquisition request, and then delivers the database to the transmission/reception control section 162. Then, the transmission/reception control section 162 controls the operation of the transmission/reception section 119 to deliver the database from the server 100 to the smartphone 1 via the transmission/reception section 19.

In the information system as the fifth embodiment having such a configuration, the information system is not completed with the smartphone 1 alone as the information terminal, but is further provided with the server 100, and is arranged that the database is stored in the storage section 117 provided to the server 100, and is transmitted to the smartphone 1 via the transmission/reception sections 19, 119 when the database identifies the measurement target X. Thus, it is possible to obtain the advantage that it becomes unnecessary to store a great deal of data in the storage section 17 provided to the smartphone 1. Further, when the information system is provided with a plurality of smartphones 1, it is possible to achieve communization of the database. Further, only by updating the database provided to the storage section 117 of the server 100, the database to be used in each of the smartphones 1 can be made the latest as a result.

Further, in the information system according to the present disclosure, when performing the identification of the measurement target X by the smartphone 1 in an off-line period, it is sufficient to arrange that the database to be required is stored in the storage section 17 provided to the smartphone 1 from the storage section 117 provided to the server 100 during the off-line period. Thus, it is possible to perform the identification of the measurement target X by the smartphone 1 even in the off-line period.

According also to such an information system as the fifth embodiment, substantially the same advantages as in the first embodiment can be obtained.

Further, although in the present embodiment, there is described when the information system according to the present disclosure has the smartphone 1 as the information terminal and the server 100, in the information system according to the present disclosure, the information terminal can be formed of a tablet terminal or the like instead of the smartphone 1, or the smartphone 1, namely the information terminal, can be constituted by a digital camera, a digital video camera, a head-up display (HUD), a head-mounted display (HMD), or the like.

Further, although in the present embodiment, it is assumed that the control section 60 provided to the smartphone 1 is provided with the light source control section 601, the spectroscopic control section 602, the image acquisition section 603, the analysis processing section 604, and the display control section 605 similarly to the first embodiment, it is also possible for the control section 160 provided to the server 100 to be provided with at least one of these sections.

### Sixth Embodiment

Then, a sixth embodiment as the information system according to the present disclosure will be described.

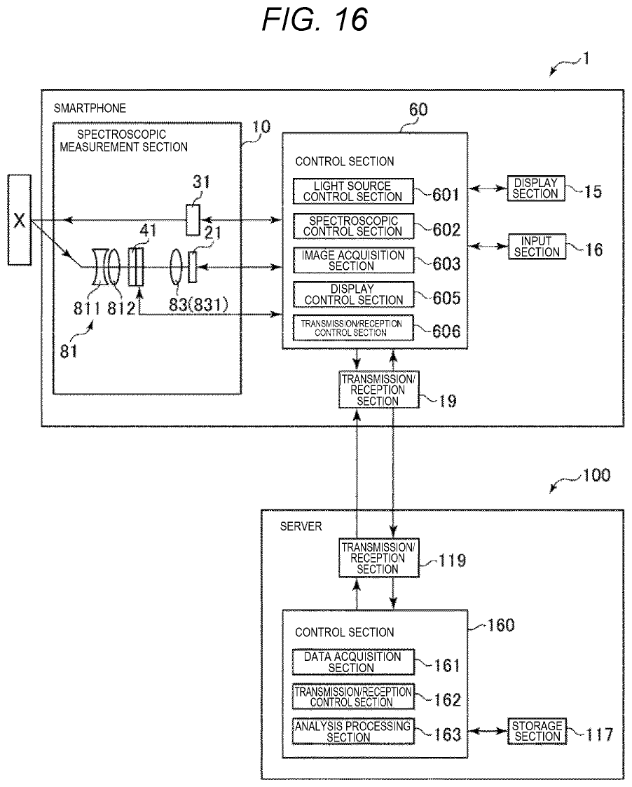

FIG. 16 is a block diagram showing a schematic configuration of a smartphone and a server to which the sixth embodiment as the information system according to the present disclosure is applied.

Hereinafter, the information system as the sixth embodiment will be described with a focus mainly on the differences from the information system as the first embodiment described above, and the descriptions regarding substantially the same matters will be omitted.

The information system as the sixth embodiment shown in FIG. 16 is substantially the same as the information system as the first embodiment described above except the point that the server 100 is further provided independently of the smartphone 1 as the information terminal. In other words, in the information system as the sixth embodiment, the information system according to the present disclosure is not completed with the smartphone 1 alone as the information terminal, but has the smartphone 1 as the information terminal and the server 100.

In the information system as the sixth embodiment, as shown in FIG. 16, the smartphone 1 does not have the storage section and the analysis processing section in the control section 60, and in contrast, the smartphone 1 further has the transmission/reception section 19, and further has the transmission/reception control section 606 for controlling the operation of the transmission/reception section 19 in the control section 60.

Further, the server 100 has the storage section 117, the transmission/reception section 119, and the control section 160, and the control section 160 has the data acquisition section 161 and the transmission/reception control section 162 for respectively controlling the operations of the storage section 117 and the transmission/reception section 119, and an analysis processing section 163 for performing the identification of the measurement target X.

In such an information system as the present embodiment, the storage section is eliminated from the smartphone 1, and the server 100 is provided with the storage section 117 instead. The storage section 117 stores a variety of types of data similarly to the storage section 17 provided to the smartphone 1 in the first embodiment described above.

Further, the analysis processing section is eliminated from the control section 60 provided to the smartphone 1, and the control section 160 provided to the server 100 is provided with the analysis processing section 163 instead. Similarly to the analysis processing section 604 provided to the smartphone 1 in the first embodiment described above, the analysis processing section 163 compares the dispersion spectrum, namely the spectroscopic information, of the measurement target X and the database with each other to thereby perform the identification of the measurement target X.

Further, the transmission/reception section 19 provided to the smartphone 1 and the transmission/reception section 119 provided to the server 100 perform delivery of a variety of types of data. Specifically, for example, the transmission/reception section 19 transmits the inherent spectroscopic information, namely the dispersion spectrum, provided to the measurement target X obtained by the smartphone 1 to the transmission/reception section 119, and receives the result of the identification of the measurement target X from the server 100 via the transmission/reception section 119. Further, the transmission/reception section 119 receives the inherent spectroscopic information, namely the dispersion spectrum, provided to the measurement target X obtained by the smartphone 1 from the smartphone 1 via the transmission/reception section 19, and transmits the result of the identification of the measurement target X to the smartphone 1 via the transmission/reception section 19. It should be noted that the delivery of the variety of types of data between the transmission/reception section 19 and the transmission/reception section 119 can be performed with wire or wirelessly, and when performing the delivery wirelessly, it is possible to perform the delivery via the Internet.

Further, the transmission/reception control section 606 provided to the smartphone 1 in the control section 60 controls the operation of the transmission/reception section 19 to transmit the dispersion spectrum, namely the spectroscopic information, of the measurement target X obtained by the image acquisition section 603 to the analysis processing section 163 provided to the server 100 via the transmission/reception section 119. Then, the analysis processing section 163 controls the operation of the data acquisition section 161 to obtain the database stored in the storage section 117, and then compares the spectroscopic information and the database with each other to thereby perform the identification of the measurement target X.

Further, the transmission/reception control section 162 provided to the server 100 in the control section 160 controls the operation of the transmission/reception section 119 to deliver the result of the identification of the measurement target X by the analysis processing section 163 from the server 100 to the smartphone 1 via the transmission/reception section 19.

In the information system as the sixth embodiment having such a configuration, the information system is not completed with the smartphone 1 alone as the information terminal, but is further provided with the server 100, and the database is stored in the storage section 117 provided to the server 100. Further, it is arranged that the identification of the measurement target X is performed based on the database in the analysis processing section 163 provided to the server 100, and then, the result of the identification of the measurement target X is transmitted to the smartphone 1 via the transmission/reception sections 19, 119. Thus, it is possible to obtain the advantage that it becomes unnecessary to store a great deal of data in the storage section 17 provided to the smartphone 1, and further it becomes unnecessary to apply a heavy calculation load to the smartphone 1. Further, by making the analysis processing section 163 excellent in processing capacity, and further making the amount of information of the database to be stored in the storage section 117 more specific, it becomes possible to more accurately identify the measurement target X.

Further, when the information system is provided with a plurality of smartphones 1, it is possible to achieve communization of the database. Further, only by updating the database provided to the storage section 117 of the server 100, the database to be used in each of the smartphones 1 can be made the latest as a result.

According also to such an information system as the sixth embodiment, substantially the same advantages as in the first embodiment can be obtained.

Further, although in the present embodiment, there is described when the information system according to the present disclosure has the smartphone 1 as the information terminal and the server 100, in the information system according to the present disclosure, the information terminal can be formed of a tablet terminal or the like instead of the smartphone 1, or the smartphone 1, namely the information terminal, can be constituted by a digital camera, a digital video camera, a head-up display (HUD), a head-mounted display (HMD), or the like.

Further, although in the present embodiment, it is assumed that the control section 60 provided to the smartphone 1 is provided with the light source control section 601, the spectroscopic control section 602, the image acquisition section 603, and the display control section 605 similarly to the first embodiment, it is also possible for the control section 160 provided to the server 100 to be provided with at least one of these sections.

As described above, although the display method, the display device, and the information system according to the present disclosure are described along the illustrated embodiments, the present disclosure is not limited to these embodiments.

For example, in the information system according to the present disclosure, each of the constituents can be replaced with an arbitrary constituent capable of exerting substantially the same function, or can also be added with what has an arbitrary configuration.

Further, in the information system according to the present disclosure, it is also possible to combine any two or more of the configurations described in the first through sixth embodiments described above with each other.

Further, in the display method according to the present disclosure, what is added with an arbitrary process can also be adopted.

What is claimed is:

1. A display method comprising:
an imaging step of imaging inherent spectroscopic information provided to an object to be measured as a first image, and taking an image of the object different from the spectroscopic information as a second image; and
a display step of inevitably displaying the second image and selectively displaying the first image out of the first image and the second image.

2. The display method according to claim 1, wherein
in the imaging step, an RGB image is obtained as the second image.

3. The display method according to claim 1, wherein
in the imaging step, the spectroscopic information at a predetermined wavelength is obtained as the first image.

4. The display method according to claim 1, wherein
in the imaging step, the spectroscopic information in a predetermined wavelength region is obtained as the first image.

5. The display method according to claim 1, wherein
in the display step, the second image is displayed alone.

6. The display method according to claim 1, wherein
in the display step, the first image and the second image are separately displayed in respective areas different from each other.

7. The display method according to claim 1, wherein
in the display step, the first image and the second image are displayed in a superimposed manner in respective areas overlapping each other.

8. A display device comprising:
a first camera configured to image inherent spectroscopic information provided to an object to be measured as a first image;
a second camera configured to take an image of the object different from the spectroscopic information as a second image; and
a display section configured to display the first image and the second image, wherein
the display section is configured to inevitably display the second image and selectively display the first image.

9. The display device according to claim 8, further comprising:
a control section configured to control operations of the first camera, the second camera, and the display section.

10. An information system comprising:
the display device according to claim 8.
